(19) United States
(12) Patent Application Publication
(10) Pub. No.: US 2025/0331018 A1
(43) Pub. Date: Oct. 23, 2025

(54) DYNAMIC TXOP IN WIRELESS NETWORKS

(71) Applicant: Samsung Electronics Co., Ltd., Suwon-si (KR)

(72) Inventors: Yue Qi, Plano, TX (US); Peshal Nayak, Plano, TX (US); Boon Loong Ng, Plano, TX (US); Vishnu Vardhan Ratnam, Frisco, TX (US); Bilal Sadiq, Plano, TX (US); Rubayet Shafin, Frisco, TX (US)

(21) Appl. No.: 19/094,667

(22) Filed: Mar. 28, 2025

Related U.S. Application Data
(60) Provisional application No. 63/637,093, filed on Apr. 22, 2024.
(60) Provisional application No. 63/679,878, filed on Aug. 6, 2024.
(60) Provisional application No. 63/688,625, filed on Aug. 29, 2024.
(60) Provisional application No. 63/688,677, filed on Aug. 29, 2024.

(51) Int. Cl. H04W 74/0808; H04W 28/06

(52) U.S. Cl. CPC H04W 74/0808; H04W 28/06

(57) ABSTRACT

An access point (AP) for facilitating communication in a wireless network. The AP has a memory; and a processor coupled to the memory. The AP obtains a transmission opportunity (TXOP) on a wireless channel. The AP determines whether a TXOP duration needs to be extended to transmit or receive low-latency traffic. The AP transmits, to a plurality of stations (STAs), a frame announcing an extension of the TXOP duration based on a determination that the TXOP duration needs to be extended, the frame including duration information associated with the extension of the TXOP duration.

### CROSS REFERENCE TO RELATED APPLICATIONS

This application claims benefit of U.S. Provisional Application No. 63/637,093, entitled “DYNAMIC TXOP FOR PREEMPTION,” filed on Apr. 22, 2024, U.S. Provisional Application No. 63/679,878, entitled “DYNAMIC TXOP FOR PREEMPTION,” filed on Aug. 6, 2024, U.S. Provisional Application No. 63/688,625, entitled “TXOP EXTENSION FOR LATE TRAFFIC IN PREEMPTION,” filed on Aug. 29, 2024, and U.S. Provisional Application No. 63/688,677, entitled “DYNAMIC TXOP FOR PREEMPTION DURATION,” filed on Aug. 29, 2024, all of which are incorporated herein by reference in their entirety.

### TECHNICAL FIELD

This disclosure relates generally to a wireless communication system, and more particularly to, for example, but not limited to, low latency traffic transmission in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for dynamic transmission opportunity (TXOP) during preemption of the TXOP.

An aspect of the disclosure provides an access point (AP) for facilitating communication in a wireless network. The AP comprises a memory and a processor coupled to the memory. The processor is configured to cause obtaining a TXOP on a wireless channel. The processor is further configured to cause determining whether a TXOP duration needs to be extended to transmit or receive low-latency traffic. The processor is further configured to cause transmitting, to a plurality of stations (STAs), a frame announcing an extension of the TXOP duration based on a determination that the TXOP duration needs to be extended, the frame including duration information associated with the extension of the TXOP duration.

In an embodiment, the processor is further configured to cause receiving, from one or more STAs, a request frame for the extension of the TXOP duration, the request frame including duration information associated with the low-latency traffic. The determining whether the TXOP duration needs to be extended comprising determining whether the low-latency traffic is allowed to be transmitted or received within the TXOP duration based on the duration information associated with the low-latency traffic.

In an embodiment, the processor is further configured to cause updating the TXOP duration to an extended TXOP duration. The processor is further configured to cause transmitting or receiving the low-latency traffic during the extended TXOP duration.

In an embodiment, the duration information associated with the extension of the TXOP duration is used for one or more legacy STAs to update a network allocation vector (NAV).

In an embodiment, the processor is further configured to cause transmitting, to one or more STAs, a request frame soliciting a buffer status report. The processor is further configured to cause receiving, from at least one of the one or more STAs, a response frame including a buffer status report in response to the request frame.

In an embodiment, the processor is further configured to cause receiving, from one or more STAs, a request frame indicating a need for preemption of the TXOP for transmitting or receiving the low-latency traffic. The processor is further configured to cause determining whether to prioritize transmitting or receiving the low-latency traffic based on the duration information associated with the low-latency traffic. The processor is further configured to cause prioritizing transmitting or receiving the low-latency traffic based on a determination to prioritize transmitting or receiving the low-latency traffic.

In an embodiment, the frame is a trigger frame to solicit the low-latency traffic.

In an embodiment, the determining whether the TXOP duration needs to be extended comprising determining whether the low-latency traffic is allowed to be transmitted within the TXOP duration by changing one or more transmission capabilities of the AP. The processor is further configured to cause changing the one or more transmission capabilities of the AP based on a determination that the low-latency traffic is allowed to be transmitted within the TXOP duration.

In an embodiment, the processor is further configured to cause determining that the AP finishes transmitting or receiving the low-latency traffic before the TXOP duration. The processor is further configured to cause transmitting a contention free (CF)-end frame that ends the TXOP after the transmitting or receiving the low-latency traffic and before the end of the TXOP duration.

In an embodiment, the processor is further configured to cause transmitting a request-to-send (RTS) frame including information associated with the TXOP duration. The processor is further configured to cause receiving a clear-to-send (CTS) frame including information associated with the TXOP duration.

An aspect of the disclosure provides a STA for facilitating communication in a wireless network. The STA comprises a memory and a processor coupled to the memory. The processor is configured to cause receiving, from an AP, a frame indicating a TXOP duration. The processor is further configured to cause transmitting, to the AP, a request frame for transmission of low-latency traffic. The processor is further configured to cause receiving, from the AP, a frame announcing an extension of the TXOP duration, the frame including duration information associated with the extension of the TXOP duration. The processor is further configured to cause transmitting, to the AP, the low latency traffic within an extended TXOP duration indicated by the duration information.

In an embodiment, the request frame includes duration information associated with the low-latency traffic.

In an embodiment, the STA is a non-legacy STA.

In an embodiment, the duration information associated with the extension of the TXOP duration is used for one or more legacy STAs to update a NAV.

In an embodiment, the processor is further configured to cause receiving, from the AP, a request frame soliciting a buffer status report. The processor is further configured to cause transmitting, to the AP, a response frame including a buffer status report indicating a duration of the low latency traffic in response to the request frame.

In an embodiment, the request frame indicates a need for preemption of the TXOP for transmission of the low-latency traffic.

In an embodiment, the frame is a trigger frame to solicit the low-latency traffic.

In an embodiment, the processor is further configured to cause receiving, from the AP, a CF-end frame that ends the TXOP before an extended TXOP duration. The processor is further configured to cause contending for a wireless channel for transmission of non-low-latency traffic.

In an embodiment, the processor is further configured to cause receiving an RTS frame including information associated with the TXOP duration. The processor is further configured to cause receiving a CTS frame including information associated with the TXOP duration.

In an embodiment, the processor is further configured to cause determining whether there is a need to adjust the STA's capabilities based on the information associated with TXOP duration and the low-latency traffic.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows a system model for DL LL traffic preemption in accordance with an embodiment.

FIG. 5 shows the probability of the DL LL PPDU exceeding TXOP limit in accordance with an embodiment.

FIG. 6 shows a system model for UL LL traffic preemption in accordance with an embodiment.

FIG. 7 shows the probability of the UL LL PPDU exceeding the TXOP limit in accordance with an embodiment.

FIG. 8 shows an example of TXOP extension in accordance with an embodiment.

FIG. 9 shows an example of dynamic TXOP in accordance with an embodiment.

FIG. 10 shows another example of dynamic TXOP in accordance with an embodiment.

FIG. 11 shows another example of dynamic TXOP in accordance with an embodiment.

FIG. 12 shows another example of dynamic TXOP in accordance with an embodiment.

FIG. 13 shows another example of dynamic TXOP in accordance with an embodiment.

FIG. 14 shows another example of dynamic TXOP in accordance with an embodiment.

FIG. 15 shows another example of dynamic TXOP in accordance with an embodiment.

FIG. 16 shows another example of dynamic TXOP in accordance with an embodiment.

FIG. 17 shows another example of dynamic TXOP in accordance with an embodiment.

FIG. 18 shows an example of dynamic TXOP in accordance with an embodiment.

FIG. 19 shows another example of dynamic TXOP in accordance with an embodiment.

FIG. 20 shows another example of dynamic TXOP in accordance with an embodiment.

FIG. 21 shows another example of dynamic TXOP in accordance with an embodiment.

FIG. 22 shows an example process of dynamic TXOP in accordance with an embodiment.

FIG. 23 shows another example process of dynamic TXOP in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

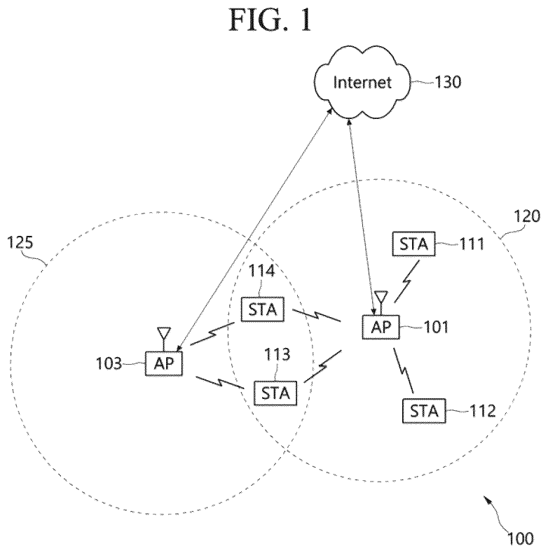

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

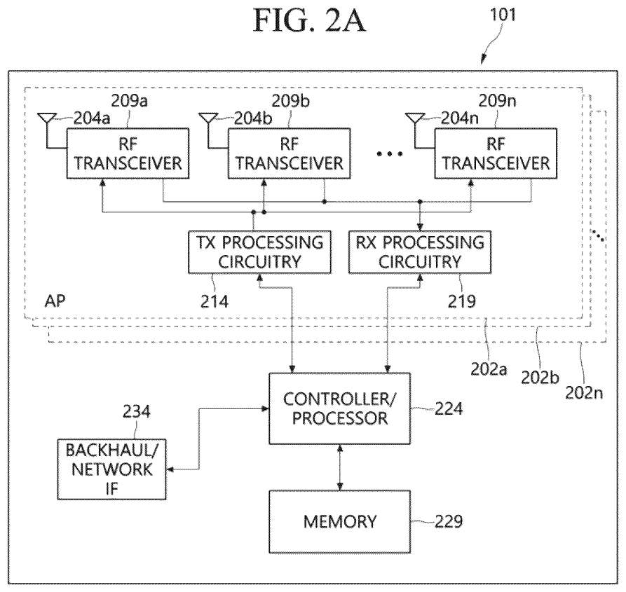

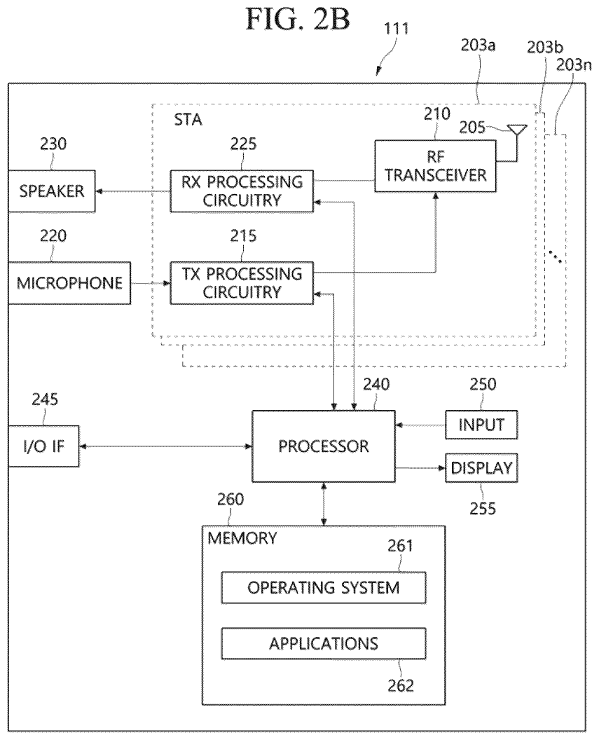

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP multi-link device (MLD) that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

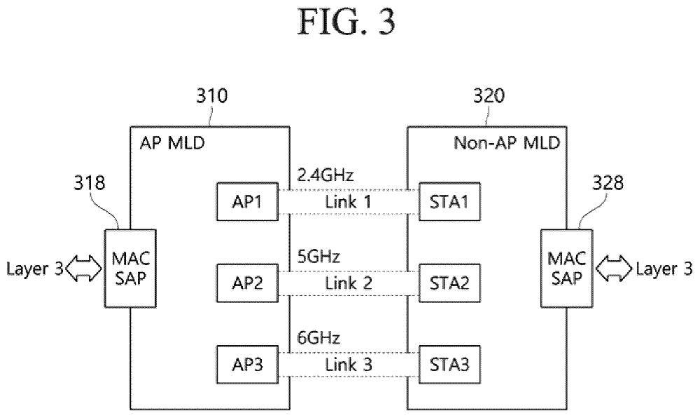

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11bc/D5.0, “Part 11: Wireless LAN Medium Access Control (MAC) and Physical Layer (PHY) Specifications—Amendment 8: Enhancements for extremely high throughput (EHT).”

In an infrastructure Wireless LAN network, a basic service set (BSS) typically refers to a network topology comprising an AP or an AP MLD, and all the non-AP devices associated with that AP or AP MLD. A BSS defines an operating bandwidth indicating the frequency resources that the devices belonging to the BSS may use for transmission, and rules on how the BSS devices may contend for the operating bandwidth. In particular, a Wireless LAN network BSS defines one of the 20 MHz channels of its operating bandwidth as the primary channel, and any device in that BSS is allowed to initiate transmission if the primary channel is sensed as IDLE after performing a required random back-off. The transmission is normally restricted to that primary 20 MHz and the duration of the transmission is called a transmit opportunity (TXOP) duration. However, if any non-primary channel of the BSS, such as a 20 MHz channel that lies within the operating bandwidth but is not the primary channel, is also sensed as IDLE for a priority interframe spacing (PIFS) duration before the time when the transmit opportunity starts on the primary channel for a Wireless LAN network device, the device man additionally also transmit on that non-primary channel. This mechanism is known as channel bonding and was further enhanced with the concept of preamble puncturing.

For any channel, primary or non-primary, a Wireless LAN network device has two channel sensing mechanisms to sense the channel state. The channel state is determined as being IDLE/BUSY. The first sensing mechanism is preamble detection where a Wireless LAN network device determines a 20 MHz channel as being BUSY if it can successfully detect a Wireless LAN network preamble on that channel with a received power higher than −82 dBm. The second sensing mechanism is energy detection where a Wireless LAN network device determined a 20 MHz channel as being BUSY if it senses any power on that channel with a received power higher than −62 dBm. A Wireless LAN network device determines a 20 MHz channel as IDLE when neither preamble detection nor energy detection determines the 20 MHz channel as BUSY.

Recently, in the discussions for the latest generation of WiFi standard, IEEE 802.11bn, significant focus has been given for the need to reduce the channel access delay for low-latency traffic required by real-time applications (RTAs). In fact, the approved PAR for IEEE 802.11bn intends to define at least one mode of operation capable of improving the tail of the latency distribution and jitter compared to Extremely High Throughput MAC/PHY operation. There is a need to reduce the low latency for the increasing demand of RTA in 11bn. Thus, more stringent requirements are needed to meet the demands of new applications, such as metaverse, augmented and virtual reality, robotics, industrial automation for industrial IoT, logistics and smart agriculture. Establishing lower latency will lead to better customer experience, particularly in the case of latency/jitter mattering. Low latency communication has become increasingly more important, becoming an essential building block for RTA. For example, some use cases require at least less than 5 ms for latency and 2 ms for jitter as shown in Table 1.

Table 1 shows characteristics of low latency traffic in use cases.

TABLE 1

| | Intra BSS Latency | | | |
|---|---|---|---|---|
| Use cases | [ms] | Jitter variance [ms] | Packet loss | Data rate [Mbps] |
| Real-time | <5 | <2 | <0.1% | <1 |
| gaming | | | | |
| Cloud gaming | <10 | <2 | Near- | <0.1 (Reverse Link) |
| | | | lossless | >5 Mbps (Forward |
| | | | | link) |
| Real-time | <3~10 | <1~2.5 | Near- | 100~28,000 |
| video | | | lossless | |

The need to deliver low latency traffic as soon as possible to support RTA STAs stems from high delay negatively affecting the RTA traffic in current networks. For example, the ongoing PHY protocol data unit (PPDU) may reach its maximum duration, such as the aPPDUMaxTime lasts 5.484 ms. This could severely delay the earliest time the low latency traffic may be delivered if the RTA traffic does not successfully contend for the resource unit (RU).

The next generation of WLAN may incorporate the concept of preemption to prioritize the low-latency (LL) traffic. In some embodiments, the preemption serves as a mechanism to stop the current ongoing transmission and initiate LL traffic transmission, ensuring that the delay bound is met in time. Most preemption solutions may feature the assumption that the LL traffic has to arrive or schedule early enough or the TXOP limits need to be long enough to cover the LL traffic. In most preemption solutions, LL traffic that arrives late may not get a chance to transmit. In such case, the TXOP holder may drop or suspend the LL packet in the current TXOP, or adjust the LL packet by power, packet size, modulation and coding scheme (MCS) or number of spatial streams (NSS), to fit within the TXOP limits. The time usage is even harder to estimate and control for the TXOP holder if the preemption is being performed by a non-TXOP holder with LL traffic.

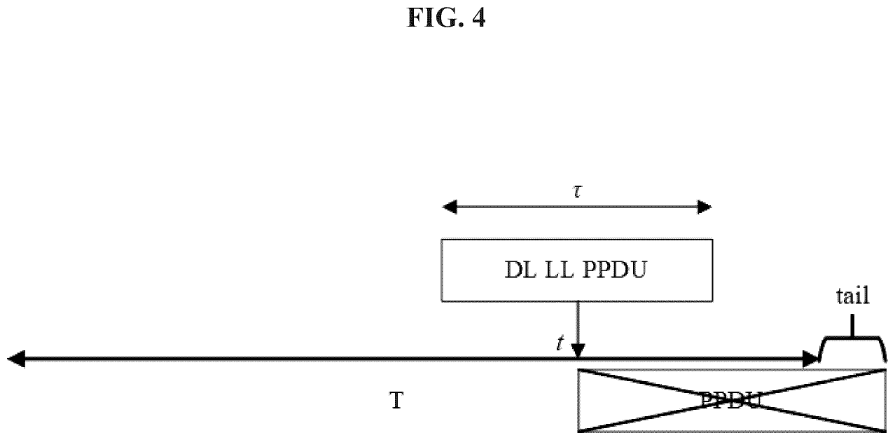

FIG. 4 shows a system model for downlink (DL) LL traffic preemption in accordance with an embodiment. The system model depicted in FIG. 4 is for explanatory and illustration purposes. FIG. 4 does not limit the scope of this disclosure to any particular implementation.

Referring to FIG. 4, DL LL traffic, in this case a DL LL PPDU, with duration t arrives at time t in the TXOP with a duration T. The LL traffic may exceed the original TXOP limit if the time remaining in T is less than τ. The LL traffic that exceeds the original TXOP is indicated as the tail of the LL PPDU.

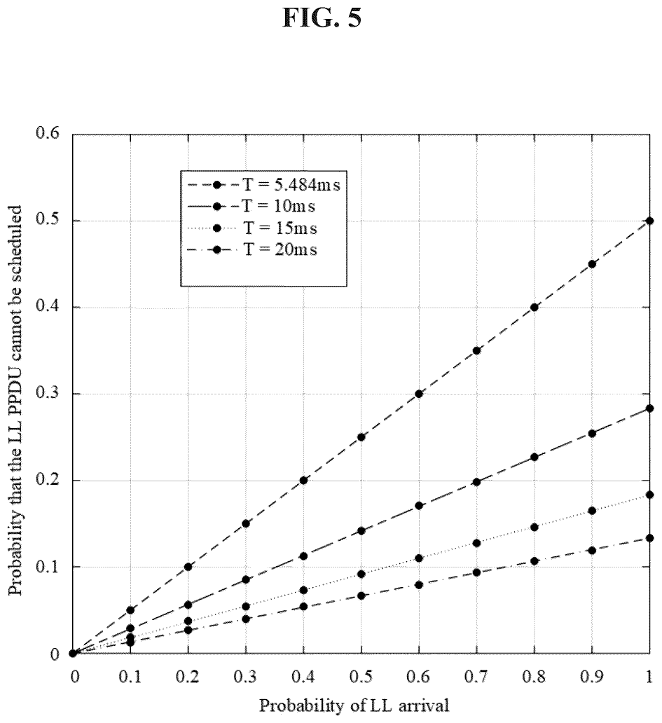

Table 2 shows the settings of a simulation resulting in the probability of DL LL traffic exceeding TXOP limit shown in FIG. 5.

TABLE 2

| Parameters | Value |
|---|---|
| T | 5 ms; 10 ms; 15 ms; 20 ms |
| PPDUMaxTime | 5.484 ms (EHT) |
| τ | U(0, PPDUMaxTime) |
| Arrival time t | U(0, T) |
| P(LL arrival)/sim. | 0:0.1:1 |
| Num of sim. | 1e6 |

In Table 2, the duration T of the TXOP is set as 5 ms, 10 ms, 15 ms, and 20 ms. The maximum PPDU length is set as 5.484 ms following EHT standard, denoted as PPDUMaxTime. Duration of the PPDU t follows the uniform distribution U(0, PPDUMaxTime). Arrival time t follows the uniform distribution U(0, T). The probability of arrival of LL traffic per simulation is from 0 to 1 with an interval of 0.1. The number of simulations is 1e6.

FIG. 5 shows the probability of the DL LL PPDU exceeding TXOP limit in accordance with an embodiment. The probability depicted in FIG. 5 is for explanatory and illustration purposes. FIG. 5 does not limit the scope of this disclosure to any particular implementation.

Referring to FIG. 5, the horizontal axis shows the probability that the LL traffic may arrive in each round of simulations which is set as from 0 to 1 with a 0.1 interval and the vertical axis shows the probability that the LL PPDU cannot be scheduled which ranges of 0 to 0.6. The probability that the LL PPDU may exceed the TXOP limits, resulting in the dropping or suspension of LL PPDU in the TXOP, is significant. This is especially significant for activities where there is a high volume of LL traffic, such as AR/VR gaming and real-time video. For example, there will be a 40% probability that the LL PPDU will be dropped off or rescheduled if the probability of the appearance of the LL PPDU is 80% when the TXOP duration is 5.484 ms.

Preemption for UL LL traffic may result in worse probabilities of dropping or rescheduling when considering that UL LL traffic has to compete with more types of traffic, such as trigger frames.

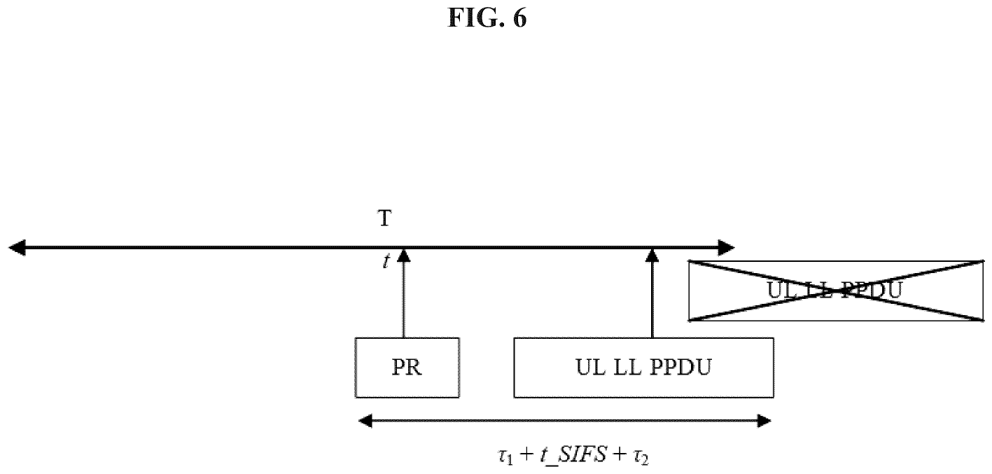

FIG. 6 shows a system model for UL LL traffic preemption in accordance with an embodiment. The system model depicted in FIG. 6 is for explanatory and illustration purposes. FIG. 6 does not limit the scope of this disclosure to any particular implementation.

Referring to FIG. 6, a preemption request (PR) with a duration of τ₁ is transmitted at time t during the TXOP duration T and then after a short interframe space (SIFS) period, the UL LL PPDU arrives with a length of 12. The duration of the PR frame τ₁ is set as 0.55 ms. The length of the UL LL PPDU τ₂ is set as U(0, PPDUMax Time). The duration of SIFS t_{SIPS} is set as 16 us for 5 GHz. Other settings, as shown in Table 2, are the same as in the DL case.

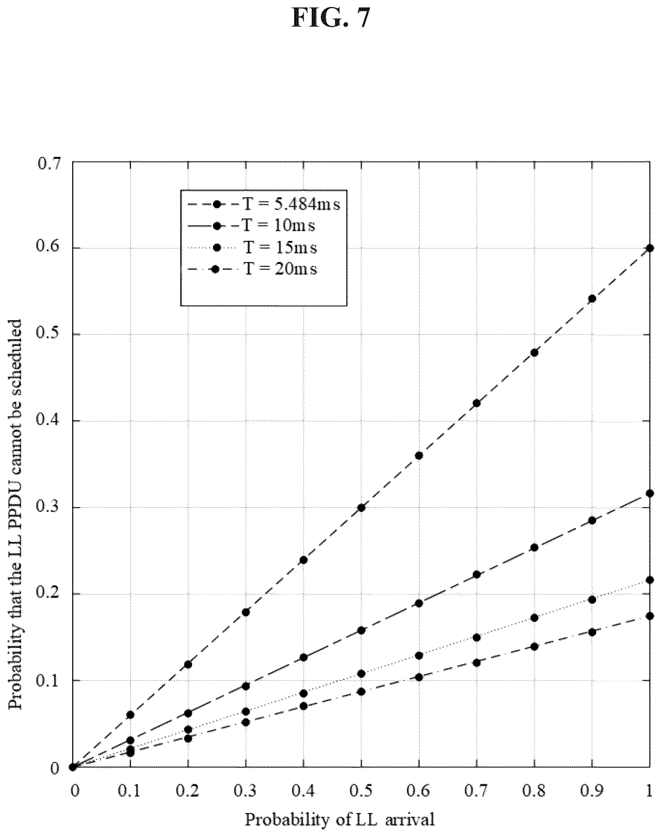

FIG. 7 shows the probability of the UL LL PPDU exceeding TXOP limit in accordance with an embodiment. The probability depicted in FIG. 7 is for explanatory and illustration purposes. FIG. 7 does not limit the scope of this disclosure to any particular implementation.

Referring to FIG. 7, the horizontal axis shows the probability that the LL traffic may arrive in each round of simulations which is set as from 0 to 1 with a 0.1 interval and the vertical axis shows the probability that the LL PPDU cannot be scheduled with ranges 0 to 0.7. The probability that the LL PPDU may exceed the TXOP limits, resulting in the dropping or suspension of LL PPDU in the TXOP, is significant. This is especially significant for activities where there is a high volume of LL traffic, such as AR/VR gaming and real-time video. For example, if the LL traffic packet will arrive for sure, so the probability of arrival is 1.0, then there is a 60% probability that the packet will be dropped off when Tis 5.484 ms.

In TXOP-based preemption, the TXOP has to be either long enough for the LL-traffic or the LL-traffic has to come early enough to get a chance to preempt. If the TXOP is too short of the LL-traffic arrives too late, the LL PPDU may be ousted from the channel and the remainder of the LL PPDU may have to contend for the channel again later. When the LL PPDU is ousted as a result of preemption and is unable to deliver its traffic then the LL PPDU has to be continuously transmitted until it successfully contends for the channel again which can cause further channel delay access.

In an embodiment, the TXOP holder may extend the TXOP based on the LL traffic which preempts the channel but arrives too late to finish during the TXOP duration. The TXOP holder or TXOP responder has the responsibility not to interfere with other scheduled traffic and is responsible for the consequences of causing any such interference.

In an embodiment, a dynamic TXOP can be defined as a TXOP that can be extended or shortened without interfering with other scheduled traffic.

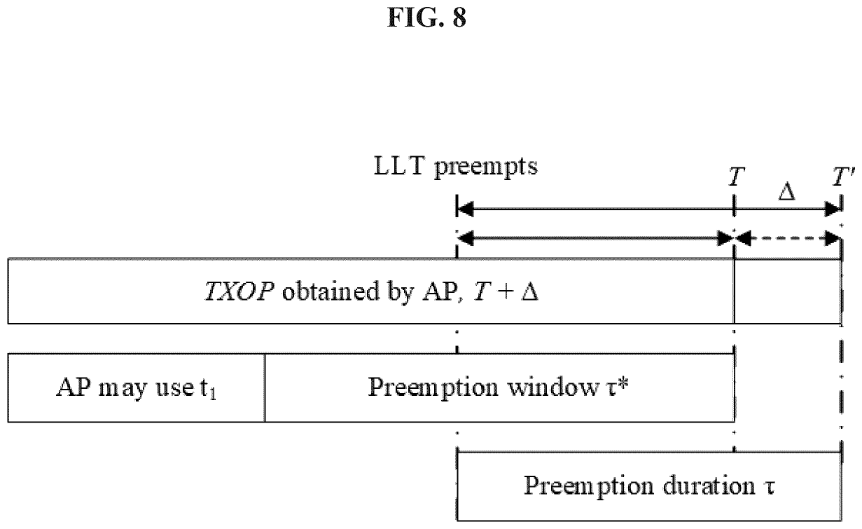

FIG. 8 shows an example of TXOP extension in accordance with an embodiment. The TXOP extension depicted in FIG. 8 is for explanatory and illustration purposes. FIG. 8 does not limit the scope of this disclosure to any particular implementation.

Referring to FIG. 8, a TXOP holder, in this case the AP, obtains a TXOP of a duration T. The AP uses the TXOP for duration T to satisfy regular traffic needs. The AP can extend the TXOP duration by duration α so that traffic can finish transmission up to a duration T′. The relationship of T, T′ and α with respect to the TXOP's duration is represented as the difference T-T′is Δ. Below the TXOP is a representation of the use of the TXOP, where the AP has used the TXOP for a duration t₁. The remainder of the TXOP is available as a preemption window, represented by τ*, where the TXOP may be used for preemption. The LL traffic arrives during the TXOP preemption window for preemption with a duration τ. The LL traffic of duration t may be unable to finish transmission before the TXOP duration T but may finish by the TXOP duration T′. The AP may extend the TXOP by Δ so that the LL traffic transmission can finish. In an embodiment, the AP may extend the duration of the TXOP, up to Δ, for finishing its own traffic after the preemption is finished, provided the AP's traffic is of a duration that can finish transmission by T′.

In an embodiment, a TXOP holder may extend the TXOP on its own determination that TXOP extension is required or if requested for TXOP extension by a non-TXOP holder. If the TXOP holder determines that TXOP extension is required, then the TXOP holder may transmit an announcement frame to nearby STAs indicating that the TXOP duration will be extended. If the TXOP holder is requested for TXOP extension then the TXOP holder may transmit a response frame to the requestor or an announcement frame to nearby STAs indicating that the TXOP duration will be extended.

In an embodiment, the LL STA may request a duration extension by indicating extension duration information in a frame. In order to extend the TXOP until T′, for example, in FIG. 8, the TXOP holder may use an extension indication frame, such as a TXOP extension announcement frame, a TXOP extension request frame, or a response frame, including information associated with the TXOP extension.

In an embodiment, the TXOP holder can transmit or broadcast the TXOP extension annoucement frame to indicate how long the current TXOP can be extended for.

In an embodiment, the TXOP holder can transmit the extension request frame to indicate how long the current TXOP can be extended for.

In an embodiment, the LL STA can transmit the extension request frame in the form of any control frame indicating the extension request.

In an embodiment, the LL STA can transmit the PR frame indicating the extension request information.

In an embodiment, the non-TXOP holders and/or the LL STAs may transmit a TXOP extension response frame indicating an acceptance of the current extension, a rejection of the current extension, or a negotiation for the duration of the extension. The TXOP extension response frame can be considered a new variant of a clear-to-send (CTS) frame.

In an embodiment, a TXOP holder may update the TXOP duration to include the \ duration or update the TXOP duration from T to T′. A TXOP responder may request that the TXOP holder update the TXOP duration. For example, the duration Δ can be Δ=t_{used}+τ−T<ζ, where t_{used} is the time the TXOP is preempted, tis the duration of the preemption, T is the original duration of the TXOP, and ζ is a threshold. In an embodiment, the duration Δ can be the duration needed for the TXOP holder and/or responder's traffic to finish during the TXOP. In an embodiment, a threshold ζ can also be indicated as a preemption extension limit to reduce the extension abuse. The TXOP holder and/or LL STAs can negotiate to determine a value for the threshold ζ. Once the extended TXOP finishes, the LL STAs can finish any ongoing LL traffic, and/or continue non-LL traffic from the TXOP holder and the responder.

Sometimes LL traffic for preemption can be interrupted by non-LL traffic belonging to legacy STAs or non-LL STAs. When this collision of traffic occurs, there is a need to update network allocation vector (NAV) setting of those legacy STAs or non-LL STAs if those STAs are awake. STAs in the power save mode (PSM) may be aware of the dynamic TXOP and set their NAV for the maximum TXOP, such as T+ζ, from the beginning.

In an embodiment, TXOP extension may not be limited to preemption, but may be used any time the TXOP holder determines TXOP extension is necessary or receives a request for TXOP extension.

An AP is the TXOP holder obtaining a TXOP for DL transmission. A DL LL PPDU intended for an LL STA may arrive too late-after a delay bound-resulting in the DL LL PPDU dropping, being suspended or being rescheduled for a later TXOP. In an embodiment, an LL STA may update the TXOP duration by requesting that the TXOP holder update the TXOP duration in order to ensure the packet is transmitted during the TXOP and is not dropped. In an embodiment, the AP can extend the TXOP by transmitting an indication frame indicating a need of a preempting traffic for a TXOP duration extension. In an embodiment, the AP may extend the TXOP or an LL STA can request that the TXOP holder extend the TXOP.

In an embodiment, the DL LL packet for LL STA may arrive too late to finish during the TXOP duration. In an embodiment, the packet may arrive early, before a delay bound, but may still not be able to finish in the TXOP duration if the TXOP holder schedules it too late.

In an embodiment, the TXOP holder can schedule the DL LL traffic early so that all traffic scheduled for the TXOP could be transmitted within the TXOP limit. In an embodiment, the TXOP holder can extend the TXOP for LL traffic during its transmission when the LL traffic arrives too late, after a delay bound or “last minute bound”. In an embodiment, the TXOP holder may extend the TXOP even when the DL LL traffic arrives early but the DL LL traffic is scheduled too late by the TXOP holder.

In an embodiment, the TXOP holder, an AP, may reset the NAV setting or extend the NAV setting for STAs in the AP's BSS when the AP extends the duration of the TXOP. In an embodiment, the TXOP holder may adjust the transmission capabilities, for example, increasing MCS or NSS, to satisfy the allocated TXOP limits. In an embodiment, the TXOP limits can be long enough to enable the preemption for ultra-high reliability (UHR) STAs. In an embodiment, the TXOP limits can be short enough to enable the preemption in the presence of legacy STAs contending for the TXOP.

In an embodiment, the TXOP responder may adjust its capability, for example, increasing MCS and NSS, to satisfy the limits associated with the allocated TXOP from the TXOP holder.

In an embodiment, a TXOP responder may support the preemption of its transmission by the TXOP holder. In an embodiment, the TXOP responder may support the preemption by resetting or updating the NAV of the TXOP responder. In an embodiment, the TXOP responder may not be aware of the preemption in the case of a DL LL preemption but the TXOP responder can keep monitoring the channel and receive the LL packet when the AP schedules the LL packet.

In an embodiment, a TXOP holder may transmit a modified request-to-send (RTS) frame with new information items in Table 3.

TABLE 3

| Subfield | Description |
|---|---|
| Dynamic duration capability | This item indicates that the current TXOP limit or duration is |
| | dynamic, and can be updated if preemption happens in some |
| | cases. A bit equaling 1 indicates that it is a dynamic TXOP limit |
| | and can be extended during the TXOP. A bit equaling 0 |
| | indicates that it is a fixed TXOP limit. |
| Maximum duration | This item indicates the maximum duration that can be extended |
| | in the TXOP. |
| Preemption capability | This item indicates the reason why the duration can be updated |
| | and the capability of preemption. A bit equaling 1 indicates that |
| | the TXOP holder does allow preemption. A bit equaling 0 |
| | indicates that the TXOP holder does not allow the preemption. |
| Number of update duration | This item indicates the maximum number of updating and |
| | extending of the TXOP duration. |

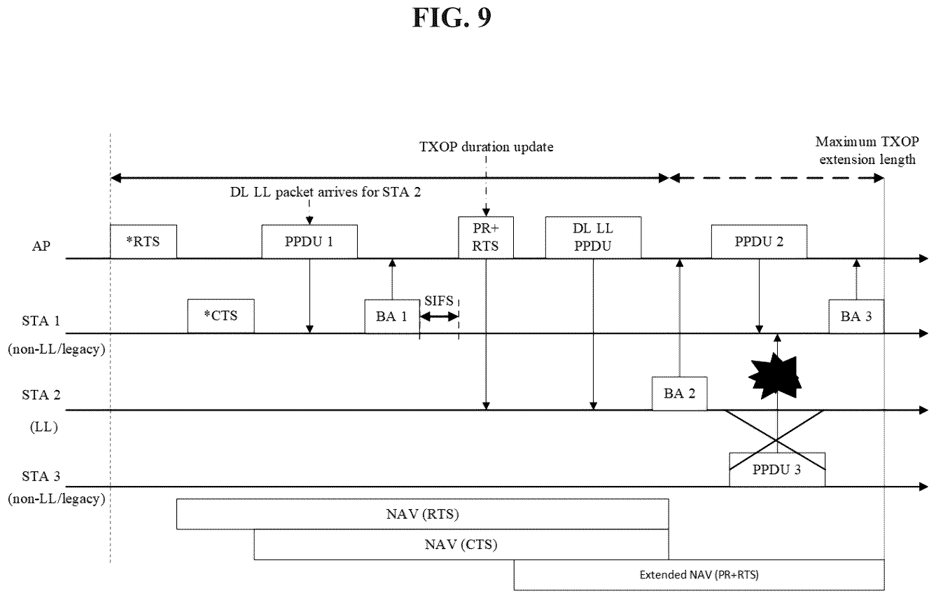

FIG. 9 shows an example of dynamic TXOP in accordance with an embodiment. The example depicted in FIG. 9 is for explanatory and illustration purposes. FIG. 9 does not limit the scope of this disclosure to any particular implementation.

Referring to FIG. 9, AP is the TXOP holder. STA 1, STA 2, and STA 3 are associated with AP. STA 1 is a TXOP responder and is a non-LL STA or a legacy STA or a UHR STA with no LL traffic in the TXOP. STA 1 supports preemption of the TXOP. STA 2 is an LL STA and is able to preempt the TXOP. STA 3 is a non-LL STA or a legacy STA that may be unaware that the TXOP is preempted. In this example, AP transmits, to STA 1, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that receive the control frame. In an embodiment, any other control frame including similar information may replace the modified RTS frame. In response, STA 1 transmits, to AP, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that receive the modified CTS frame. In an embodiment, any other control frame including similar information may replace the modified CTS frame. In response, AP transmits, to STA 1, a frame (PPDU 1). During the transmission of the PPDU 1 to STA 1, a DL LL packet for STA 2 arrives in the TXOP. In response to the PPDU 1, STA 1 transmits, to AP, a block acknowledgement (BA) 1 frame. After the expiration of the SIFS following the BA 1 frame, AP transmits, to STA2, an announcement frame that includes a duration field for the updated TXOP and NAV setting. In this example, the announcement frame is referred to as a PR+RTS frame, which may be another variant of RTS frame including a PR request. In response, STA3 updates the NAV setting based on the duration field of the announcement frame. Subsequently, AP transmits, to STA 2, a DL LL PPDU including the DL LL packet. In response, STA 2 transmits a BA 2 frame within the extended TXOP duration. Subsequently, AP transmits, to STA 1, a PPDU 2. The transmission of the PPDU 2 occurs during the extended duration of the TXOP. A STA, for example STA 3, may not be aware of the extension of the TXOP duration if the NAV setting of STA 3 had not been updated by the announcement frame. In the case where STA 3 did not have its NAV setting updated, STA 3 may have transmitted PPDU 3 to STA 1 during AP's transmission of PPDU 2 resulting in collision. In response, STA 1 transmits, to AP, a BA 3 frame.

In an embodiment, in the example shown in FIG. 9, AP and STA 1 and STA 2 may have negotiated prior to the transmission of the modified RTS frame so that STA 1 and STA 2 do not update their NAV settings for the modified RTS frame.

In an embodiment, STA 2 may be aware of the dynamic TXOP in the beginning of the example and stay awake during the whole TXOP. In an embodiment, STA 2 may not have to be awake during the whole TXOP, only being awake until the PR frame is received including buffer status information. In an embodiment, STA 2 may wake up periodically to monitor the buffer from the TXOP holder, in this case AP.

In an embodiment, the information items of Table 3 can be included in the Frame Control field of the modified RTS frame and the modified CTS frame. In an embodiment, the maximum duration can also be included in the Duration field of the modified RTS frame and the modified CTS frame so that STA 3 can understand and update the NAV setting for the whole TXOP. In the example of FIG. 9, STA3 may update its NAV setting to the maximum duration of the TXOP when receiving the modified RTS frame. In an embodiment, STA 3 may notice the maximum duration of the TXOP from the modified RTS frame and/or modified CTS frame, indicating a dynamic TXOP with maximum length. Accordingly, STA 3 may update its NAV setting from the beginning to avoid potential collision of the extended TXOP.

In an embodiment, in the example of FIG. 9, AP or STA 2 may indicate to other STAs that AP and/or STA 2 are busy so that other STA will avoid trying to perform transmissions with the TXOP or attempt preemption of the TXOP with AP or STA2.

In an embodiment, AP only considers one-time extension during the TXOP. In an embodiment, AP considers multiple times of extension during the TXOP and the maximum extension time is defined which may be included as one of the information items in the modified RTS frame and/or the modified CTS frame.

In an embodiment, a control frame including a PR indication, such as an PR+RTS frame, may extend the duration of the TXOP by the TXOP holder when the DL LL packet arrives. The extended duration can be included in the Duration field of the modified RTS frame. The PR can be included in the Frame Control field of the modified RTS frame, which may be referred to as a dynamic RTS frame or PR+RTS frame. STAs that receive the modified RTS frame may need to update their NAV setting. The dynamic RTS frame or PR+RTS frame may include information items such as shown in Table 4.

TABLE 4

| Subfield | Description |
|---|---|
| Extended duration | This item indicates the duration |
| | that needs to be extended. |
| Maximum duration | This item indicates the |
| | maximum TXOP extension limit. |

In an embodiment, the STAs in PSM that may be unable to receive the modified RTS frame and may be unaware of the dynamic TXOP. The STAs in PSM may be unable to receive the modified CTS frame and may be unaware of the dynamic TXOP. In this case, the PSM STAs can update their NAV setting to the maximum duration. The maximum duration can also be included in the Duration field of the modified RTS frame and the Duration field of the modified CTS frame such that the legacy STA can understand the extended TXOP.

In an embodiment, the dynamic RTS frame or PR-RTS frame can be considered using the A (aggregated)-control field.

In an embodiment, a dynamic CTS frame may follow the transmission of the dynamic RTS frame after SIFS or PIFS to update the NAV setting for the STA receiving the dynamic CTS frame.

In an embodiment, the DL LL PPDU may also be able to update the TXOP duration such as in the PHY header or preamble with UHR-SIG. In an embodiment, a TXOP holder with a DL LL PPDU may also broadcast an extension announcement following the DL LL PPDU to inform other STAs of TXOP extension. The extension announcement frame may include the extended duration and maximum duration, for example, the new information items indicated in Table 4.

The duration for DL TXOP can be extended by t_{used}+tₗ−T>0 when the LL traffic arrives too late to finish by the original duration for the DL TXOP. The t_{used} is the time that has been used by the TXOP holder and responder. The tₗ is the time that the LL DL traffic will use the TXOP, which may include 2*SIFS, the duration of the LL PPDU or the duration of BA. T is the duration of the original TXOP duration.

In an embodiment, the TXOP holder may receive a PR frame within a shorter IFS (XIFS) after any transmission to the TXOP responder or any transmission from the TXOP responder. In an embodiment, the PR frame may come from different spatial streams.

In an embodiment, the TXOP holder may transmit a trigger frame, such as basic trigger frame, an null data PPDU (NDP) feedback report poll (NFRP) trigger frame or buffer status report (BSR) poll (BSRP) trigger frame. According to an embodiment, the PR frame may come from different spatial streams. The TXOP duration may be updated in those trigger frames.

In an embodiment, the TXOP responder that is preempted may sense a busy channel and stop receiving or transmitting if a PR frame is transmitted or interrupted within a shorter IFS.

In an embodiment, a TXOP responder that receives a trigger frame may access the random-access resource units (RARU). In an embodiment, LL STAs may reply to an NFRP trigger frame and BSRP trigger frame with an NDP feedback report (NFR) frame and BSR frame, respectively, for resource allocation.

In an embodiment, an LL STA may transmit the PR frame to the TXOP holder (e.g., AP) indicating the resource it may need or the duration it may require.

In an embodiment, a TXOP holder or an LL STA may transmit a PR frame that may indicate to other STAs that it is busy in order to prevent additional preemption and/or transmission to the LL STAs.

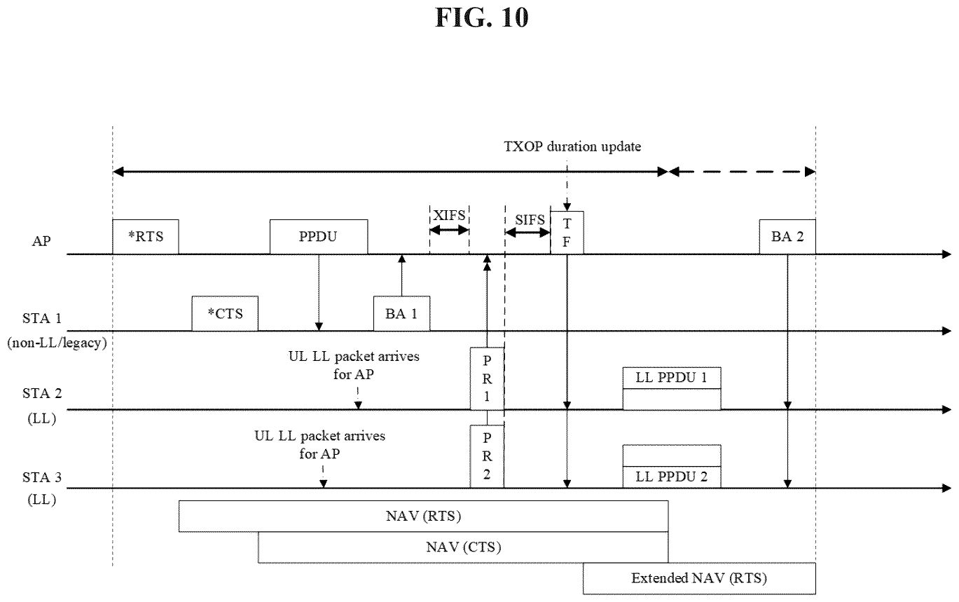

FIG. 10 shows another example of dynamic TXOP in accordance with an embodiment. The example depicted in FIG. 10 is for explanatory and illustration purposes. FIG. 10 does not limit the scope of this disclosure to any particular implementation.

Referring to FIG. 10, AP is a TXOP holder. STA 1, STA 2 and STA 3 are associated with AP. STA 1 is a TXOP responder and is a non-LL STA or a legacy STA or a UHR STA with no LL traffic in the TXOP. STA 1 supports preemption of the TXOP. STA 2 and STA 3 are LL STAs and are able to preempt the TXOP. In this examples, AP transmits, to STA 1, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. STA 3 may update its NAV setting upon receiving a modified RTS frame from AP or a modified CTS frame from STA 1. STA 2 may not update its NAV setting because AP, STA 1, and STA 2 have negotiated that STA 2 prior to the transmission of the modified RTS frame. In response, STA 1 transmits, to AP, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, AP transmits, to STA 1, a frame (PPDU) intended for STA 1. During the PPDU transmitted by AP, a UL LL packet arrives for AP from STA 3. Subsequently, a UL LL packet arrives for AP from STA 2. In response to the PPDU from AP, STA 1 transmits, to AP, a BA 1 frame in response to receiving the PPDU from AP. A XIFS period after the BA 1 frame, STA 2 transmits, to AP, a PR 1 frame requesting preemption for its transmission including its UL LL packet for AP. At the same time, STA 3 transmits, to AP, a PR 2 frame requesting preemption for its transmission including it UL LL packet for AP. A SIFS period after the PR 1 frame and the PR 2 frame, AP transmits, to STA 2 and STA 3, a trigger frame (TF) that solicits uplink frames. The TF frame includes duration information to update or extend the TXOP duration. In response, STA 2 transmits, to AP, a frame (LL PPDU 1). STA 3 transmits, to AP, a frame (LL PPDU 2). Other STAs update their NAV settings to the duration information included in the TF frame. STA 1, STA 2, and STA 3 do not update their NAV settings according to the information included in the modified RTS frame based on a negotiation prior to the transmission of the modified RTS frame. In response, AP transmits, to STA 2 and STA 3, a BA 2 frame during the extended TXOP duration.

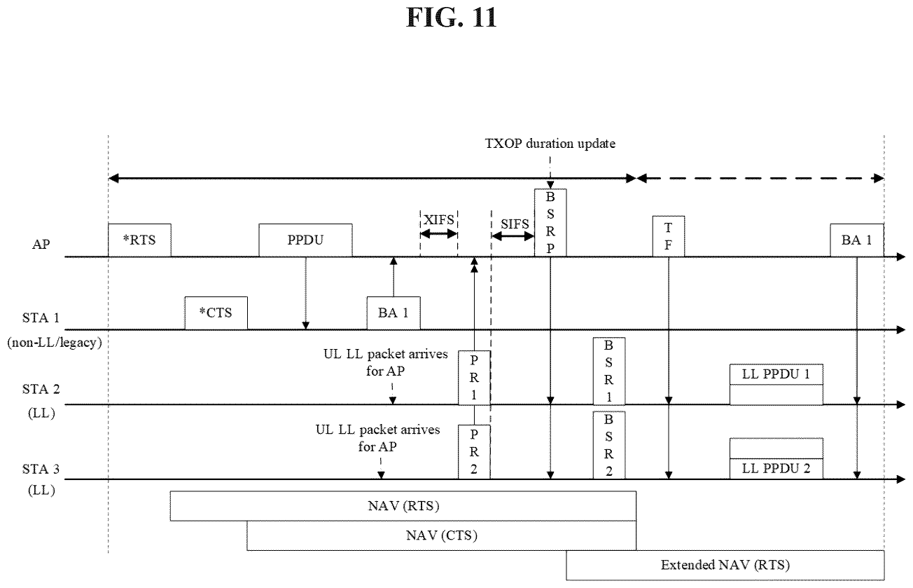

FIG. 11 shows another example of dynamic TXOP traffic in accordance with an embodiment. The example depicted in FIG. 11 is for explanatory and illustration purposes. FIG. 11 does not limit the scope of this disclosure to any particular implementation.

Referring to FIG. 11, AP is a TXOP holder. STA 1, STA 2 and STA 3 are associated with AP. STA 1 is a TXOP responder and is a non-LL STA or a legacy STA or a UHR STA with no LL traffic in the TXOP. STA 1 supports preemption of the TXOP. STA 2 and STA 3 are LL STAs and are able to preempt the TXOP. AP transmits, to STA 1, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, STA 1 transmits, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, AP transmits, to STA 1, a frame (PPDU) intended for STA 1. STA 1 transmits, to AP, a BA 1 frame in response to receiving the PPDU from AP. During the BA 1 frame transmitted by STA 1, a UL LL packet arrives for AP from STA 3. During the BA 1 frame transmitted by STA 1, a UL LL packet arrives for AP from STA 2. A XIFS period after the BA 1 frame, STA 2 transmits, to AP, a PR 1 frame requesting preemption for its transmission including its UL LL packet for AP. At the same time, STA 3 transmits, to AP, a PR 2 frame requesting preemption for its transmission including its UL LL packet for AP. A SIFS period after the PR 1 frame and the PR 2 frame, AP transmits, to STA 2 and STA 3, a BSRP frame that solicits a BSR frame and updates the TXOP duration. STA 2 transmits, to AP, a BSR 1 frame in response to the BSRP frame. STA 3 transmits, to AP, a BSR 2 frame in response to the BSRP frame. In response, AP transmits, to STA 2 and STA 3, a TF that solicits uplink frames. The TF frame includes duration information to update or extend the TXOP duration. In response, STA 2 transmits, to AP, a frame (LL PPDU 1). STA 3 transmits, to AP, a frame (LL PPDU 2). Other STAs update their NAV settings to the duration information included in the TF frame. STA 1, STA 2, and STA 3 do not update their NAV settings according to the information included in the modified RTS frame based on a negotiation prior to the transmission of the modified RTS frame. In response, AP transmits, to STA 2 and STA 3, a BA 2 frame during the extended TXOP duration.

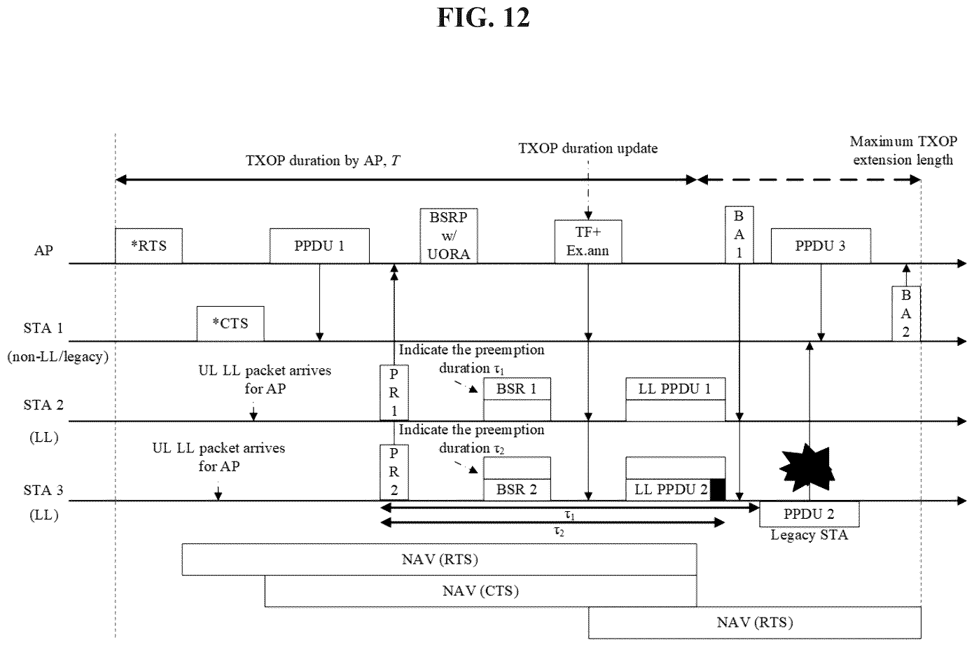

FIG. 12 shows another example of dynamic TXOP in accordance with an embodiment. The example depicted in FIG. 12 is for explanatory and illustration purposes. FIG. 12 does not limit the scope of this disclosure to any particular implementation.

Referring to FIG. 12, AP is a TXOP holder. STA 1, STA 2 and STA 3 are associated with AP. STA 1 is a TXOP responder and is a non-LL STA or a legacy STA or a UHR STA with no LL traffic in the TXOP. STA 1 supports preemption of the TXOP. STA 2 and STA 3 are LL STAs and are able to preempt the TXOP. AP transmits, to STA 1, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, STA 1 transmits, to AP, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. During the modified CTS frame transmitted by STA 1, a UL LL packet arrives for AP from STA 3. During the modified CTS frame transmitted by STA 1, a UL LL packet arrives for AP from STA 2. In response, AP transmits, to STA 1, a frame (PPDU 1) for its traffic for STA 1. Subsequently, STA 2 transmits, to AP, a PR 1 frame requesting preemption for its transmission including its UL LL packet for AP. STA 3 transmits, to AP, a PR 2 frame requesting preemption for its transmission including its UL LL packet for AP. In response, AP transmits, to STA 2 and STA 3, a BSRP w/UL orthogonal frequency division multiple access (OFDMA)-based random access (UORA) frame soliciting a BSR frame. In response, STA 2 transmits, to AP, a BSR 1 frame indicating preemption duration τ₁. STA 3 transmits, to AP, a BSR 2 frame indicating preemption duration τ₂. In response, AP transmits, to STA 2 and STA 3, a TF+extension announcement (EX. ann) frame that solicits uplink frames. The TF frame includes duration information to update or extend the TXOP duration, announces the TXOP duration information to other STAs that receive the TF frame, and updates the TXOP duration based on τ₁ and τ₂. In response, STA 2 transmits, to AP, a frame (LL PPDU 1). STA 3 transmits, to AP, a frame (LL PPDU 2). In response, AP transmits, to STA 2 and STA 3, a BA 1 frame. In an embodiment, a legacy STA may transmit a PPDU 2 to STA 1 after the channel is clear and the original TXOP duration has completed without notice of the TXOP extension. The TF+Ex. ann. frame gives notice to such legacy STAs about the extension to avoid a possible collision between the PPDU 2 and any remaining traffic of AP to STA 1. Subsequently, AP transmits, to STA 1, a frame (PPDU 3) for its traffic for STA 1. In response, STA 1 transmits, to AP, a BA 2 frame.

In an embodiment, the extended duration can be indicated in the trigger frame, the BSRP frame, the BSR frame or the PR frame, with TXOP information, such as, the dynamic duration capability of the TXOP, the maximum duration of the TXOP, the preemption capability of the TXOP and the number of updates to the TXOP duration, for example, the information items shown in Table 3.

In an embodiment, an extension frame can be used to extend the TXOP duration. In an embodiment, an extension announcement frame indicating the TXOP extension can be broadcasted to STAs in the AP's BSS.

In an embodiment, an extension request frame or an extension announcement frame can be used to extend the duration. The extension announcement frame may be included in a basic trigger frame, for example, the TR+Ex. Ann. frame. The extension announcement may include information indicating the maximum value for TXOP extension and the duration extension for the TXOP extension, as shown in Table 5.

TABLE 5

| Subfield | Description |
|---|---|
| Maximum value for extension | This item indicates the maximum duration that can be |
| | extended in this TXOP |
| Duration for extension | This item indicates the actual value that the STA is going to |
| | extend for this TXOP |

In an embodiment, a TXOP holder may extend the TXOP duration based on factors including the existing duration, the maximum duration, and the needed duration. In an embodiment, STAs may not be aware of an extension of the TXOP duration, such as non-LL STAs or legacy STAs. The TXOP holder may then reset or update the NAV for non-LL STAs or legacy STAs, so that the LL traffic or the scheduled non-LL traffic may transmit in the extended TXOP portion without interference from the non-LL or legacy STAs. An example of the extension time in FIG. 12 can be Δ=t_{used}+max(τ₁, τ₂)−T. τ₁ in this example is the duration that STA 2 may need for preemption. τ₂ in this example is the duration that STA 3 may need for preemption. t_{used} is the duration of the TXOP already used. T is the original duration of the TXOP.

In an embodiment, after receiving an extension announcement frame from a TXOP holder, a TXOP responder or LL STA may transmit a response frame indicating an agreement if the TXOP responder or LL STA agrees to extending the TXOP duration. Otherwise, the TXOP responder or LL STA may transmit a response to reject the extension including with a reason code after which the TXOP is terminated. In an embodiment, if a TXOP responder or LL STA agrees to extending the TXOP duration, then the TXOP responder or LL STA may reset its NAV and indicate its agreement in its ongoing PPDUs. Otherwise, the TXOP responder or LL STA may transmit a response to reject the extension including a reason code after which the TXOP is terminated.

In an embodiment, a TXOP responder may reject the extension of TXOP duration if the TXOP responder has another schedule, for example a target wake time (TWT) in the time following the TXOP duration. The extension request and response frame should respect an existing schedule, such as the TWT in the time following the TXOP duration. If the extended duration is long enough to interfere with the existing schedule, the TXOP holder and TXOP responder may not be able to extend the TXOP duration. The TXOP holder and TXOP responder may still extend the TXOP duration so long as the extension ends before the existing schedule begins, including consideration of any relevant IFS. If the TXOP holder or responder controls the next schedule, the TXOP holder or responder may determine whether to extend the TXOP without consideration of acceptance or rejection of other STAs. If a TXOP responder controls the next schedule and the next schedule comprises the TXOP responder's traffic with other STAs, the TXOP responder may indicate the extension length for the TXOP duration extension.

In an embodiment, the modified RTS frame may indicate if the TXOP can be preempted or not. The modified RTS frame may also indicate the longest duration that the TXOP can be extended to avoid any interference. The modified CTS frame may indicate if the TXOP can be preempted or not. The modified CTS frame may also indicate the longest duration that the TXOP can be extended to avoid any interference.

In an embodiment, TXOP extension announcement frame information, TXOP extension request frame information and response frame information can also be included in any control frame. The control frame may be an modified RTS frame, a modified CTS frame or a trigger frame. An modified RTS frame with extension information can be transmitted by a TXOP holder. A modified CTS frame with extension confirmation can be transmitted by the TXOP responder.

In an embodiment, the PR frame may include the duration requirement that the TXOP responder needs for its LL traffic to preempt the TXOP. For example, STA 2 may need preemption duration τ₁ for its transmission and STA 3 may need preemption duration 12 for its transmission. The transmissions for both STA 2 and STA 3 may be performed in different resources in the extended TXOP so long as the extension duration is the greater of τ₁ and τ₂. In an embodiment, AP may also transmit a BSRP frame to determine the duration requirements for the transmissions of STA 2 and STA 3. STA 2 can respond to the BSRP with a BSR frame including the preemption duration τ₁. STA 3 can respond to the BSRP with a BSR frame including the preemption duration τ₂. In an embodiment, a PR frame may instead update the TXOP duration with a default maximum duration.

In an embodiment, the trigger frame transmitted by a TXOP holder may update the TXOP duration. The trigger frame may include TXOP information, such as, the dynamic duration capability of the TXOP, the maximum duration of the TXOP, the preemption capability of the TXOP and the number of updates to the TXOP duration, for example, the new information items of Table 3. In an embodiment, the trigger frame may also reset the NAV for STAs in the TXOP holder's BSS. In an embodiment, a dynamic RTS frame or dynamic CTS frame may also be transmitted after the PR frame or the trigger frame.

In an embodiment, a preempting LL STA may respond to a BSRP frame by transmitting a BSR frame. The BSR frame may include preemption duration t of the preempting LL STA. A TXOP holder can determine the duration required by a plurality of LL STAs based on the preemption durations included in BSR frames received from the plurality of LL STAs. The TXOP holder can extend the TXOP duration where the TXOP holder determines that the extended TXOP duration is sufficient to finish transmission of the traffic of the plurality of the LL STAs and/or the TXOP holder and responder. In an embodiment, the trigger frame may update the TXOP duration accordingly.

In an embodiment, if LL traffic arrives too late to finish transmission within the original TXOP duration, the duration for DL TXOP can be extended by duration \=t_{used}+max(τ₁, τ₂)−T>0. The t_{used} is the time that has been used by the TXOP holder and responder. τ₁ is the time that first DL LL traffic will use. 12 is the time that second DL LL traffic will use. The preemption durations τ₁ and τ₂ may include 3*SIFS, the duration of a PR frame, the duration of a TF, the duration of a LL PPDU, the duration of a BA frame or possibly the duration of another set of modified RTS frame and modified CTS frame. T is the duration of the original TXOP. In an embodiment, τ₁ and τ₂ may just include the duration of the LL PPDU, and the trigger frame may consider the remainder of the duration as limiting factors, such as SIFS or padding. A transmission of LL PPDU needs to be aligned by padding where different frequency resources are used for the transmission of the LL PPDU.

In an embodiment, an LL STA with LL traffic that requires preemption can estimate the preemption duration τ, and the LL STA can indicate the preemption duration t before the TXOP duration begins. The LL STA may be made aware of the maximum duration indicated by the TXOP holder in a control frame, such that t will not cause the TXOP duration to exceed the maximum duration. In an embodiment, the TXOP holder or TXOP responder can use a default fixed value, where τ=t*.

In an embodiment, a non-AP STA can be the TXOP holder to transmit a UL PPDU to an AP. The AP can be the preempting STA that preempts the TXOP holder and transmits an LL PPDU to the TXOP holder or the AP can transmit a DL PPDU to a LL STA.

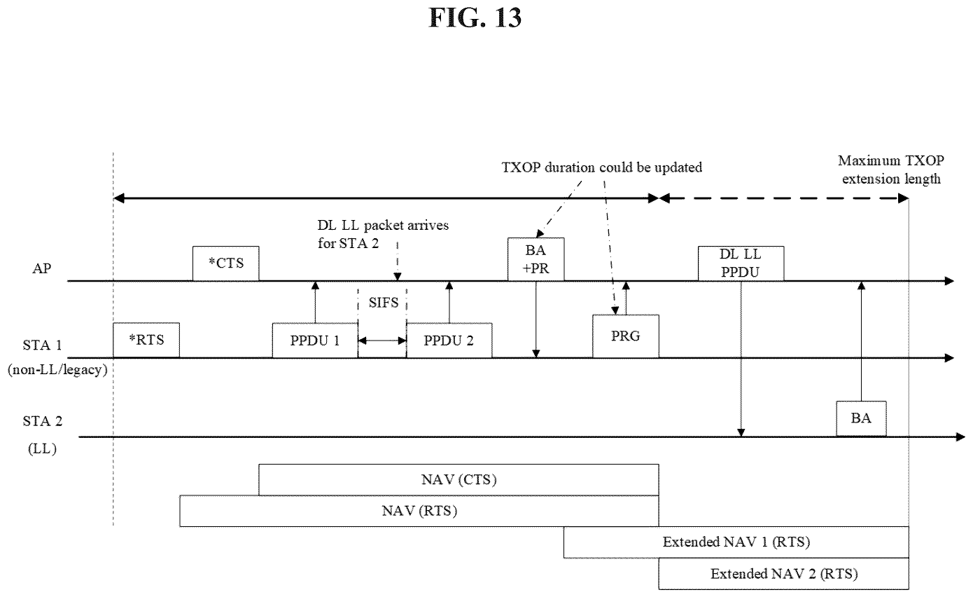

FIG. 13 shows another example of dynamic TXOP in accordance with an embodiment. The example depicted in FIG. 13 is for explanatory and illustration purposes. FIG. 13 does not limit the scope of this disclosure to any particular implementation.

Referring to FIG. 13, STA 1 is a TXOP holder and is a non-LL STA or a legacy STA or a UHR STA with no LL traffic in the TXOP. STA 1 and STA 2 are associated with AP. AP is a TXOP responder and supports preemption of the TXOP. STA 2 is an LL STA and is able to preempt the TXOP. STA 1 transmits, to AP, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, AP transmits, to STA 1, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, STA 1 transmits, to AP, a frame (PPDU 1) as part of its periodic traffic to AP. During the SIFS period after the PPDU 1 and before a subsequent frame (PPDU 2), a DL LL packet arrives for STA 2 from AP. Subsequently, STA 1 transmits, to AP, the PPDU 2 as part of its periodic traffic to AP. Subsequently, AP transmits, to STA 1, a BA+PR frame acknowledging the PPDU 1 and the PPDU 2, and requesting preemption for its transmission of the DL LL packet for STA 2. AP may update the TXOP duration with the BA+PR frame. The BA+PR can update the NAV setting for STAs that receive the BA+PR frame. In response, STA 1 transmits, to AP, a PR grant/response (PRG) frame agreeing to the preemption request and updating the TXOP duration to extend sufficiently to allow the preemption. The PRG frame can update the NAV setting for STAs that receive the PRG frame. In response, AP transmits, to STA 2, a frame (DL LL PPDU) including the DL LL packet for STA 2. In response, STA 2 transmits, to AP, a BA frame acknowledging the DL LL PPDU.

In an embodiment, the AP may transmit an extension request frame including information indicated in the BA+PR frame. In an embodiment, the AP may transmit an extension request frame after the BA+PR frame. TXOP holder may transmit a frame accepting the preemption request including the extended TXOP duration. The frame accepting preemption may be a TXOP response frame or a TXOP announcement frame.

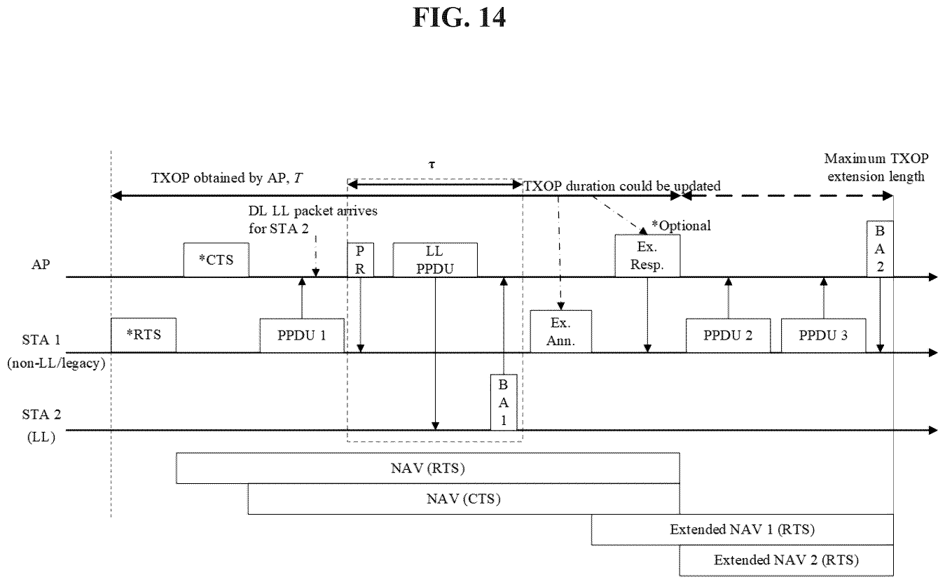

FIG. 14 shows another example of dynamic TXOP in accordance with an embodiment. The example depicted in FIG. 14 is for explanatory and illustration purposes. FIG. 14 does not limit the scope of this disclosure to any particular implementation.

Referring to FIG. 14, STA 1 is a TXOP holder and is a non-LL STA or a legacy STA or a UHR STA with no LL traffic in the TXOP. STA 1 and STA 2 are associated with AP. AP is a TXOP responder and supports preemption of the TXOP. STA 2 is an LL STA and is able to preempt the TXOP. STA 1 transmits, to AP, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, AP transmits, to STA 1, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, STA 1 transmits, to AP, a frame (PPDU 1) as part of its periodic traffic with AP. During the PPDU 1, a DL LL packet arrives for STA 2 from AP. In response, AP transmits, to STA 1, a PR frame requesting preemption for its transmission of the DL LL packet for STA 2. Subsequently, AP transmits, to STA 2, a frame (LL PPDU) including the DL LL packet for STA 2. In response, STA 2 transmits, to AP, a BA frame acknowledging the LL PPDU. Subsequently, STA 1 transmits, to AP, an extension announcement frame updating the TXOP duration including information associated with the extended duration. The extended duration provides sufficient time for the transmission of STA 1's traffic to finish during the extended TXOP duration. In response AP transmits, to STA 1, an extension response frame agreeing to the extension and updating the TXOP duration accordingly. In an embodiment, AP transmitting, to STA 1, the extension response frame is optional. Subsequently, STA 1 transmits, to AP, a frame (PPDU 2) as part of its periodic traffic with AP during the extended TXOP. Following the PPDU 2, STA 2 transmits, to AP, a frame (PPDU 3) as part of its periodic traffic with AP. In response, AP transmits, to STA 1, a BA frame acknowledging the periodic traffic.

In an embodiment, the TXOP holder may extend the TXOP duration by transmitting an extension request frame. The TXOP responder may respond by transmitting an extension response frame agreeing to the extension. In an embodiment, the TXOP holder may transmit an extension announcement frame to STAs in the same BSS as the TXOP holder. STAs transmitting the extension response frame can be optional.

In an embodiment, an AP, a TXOP responder, may transmit a PR+BA frame when the AP request to extend the TXOP duration. In an embodiment, the AP may also transmit a frame (PR frame) including the information of the PR separately from a frame (BA frame) including the information of the BA. The AP may update the TXOP duration using the PR frame and the BA frame. In an embodiment, a STA, a TXOP holder, may transmit a PRG frame including an updated TXOP duration. Therefore, all other STAs around the AP and TXOP holder may be aware of the updated TXOP duration.

In an embodiment, the PR frame that the TXOP holder or the preempting LL STA transmits indicates to other STAs that the TXOP holder or the preempting LL STA are busy. The indication to other STAs that TXOP holder or the preempting LL STA are busy prevents additional preemption of the TXOP and/or contention for transmission on the TXOP. In an embodiment, a TXOP holder may instead consider using an extension request frame and an extension response frame if the TXOP holder prefers acquiring a longer extended duration to finish its one non-LL transmission.

In an embodiment, the AP may transmit a preemption request frame and the TXOP holder may transmit a preemption response frame. The preemption request frame or preemption response frame can update the NAV setting for STAs that receive either frame. The extended TXOP duration is determined by the AP and the TXOP holder when the TXOP holder agrees to the preemption extension. In an embodiment, the TXOP holder can transmit an extension announcement frame. The extension announcement frame updates the NAV setting for STAs that receive the frame.

In an embodiment, a non-AP STA may be a TXOP holder, and transmit a UL PPDU to an AP, a TXOP responder. A third party, such as an LL STA capable of preemption, may preempt the TXOP to transmit a LL PPDU to the AP.

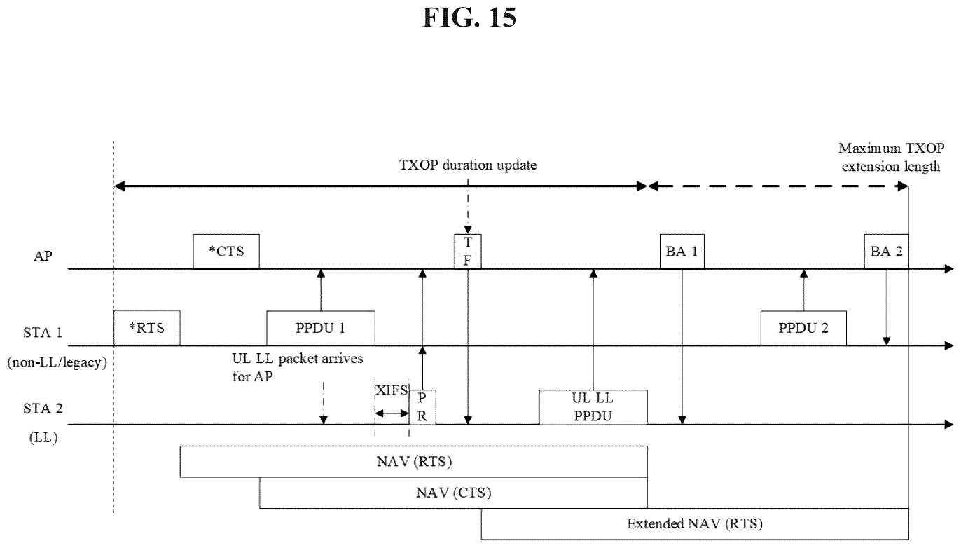

FIG. 15 shows another example of dynamic TXOP in accordance with an embodiment. The example depicted in FIG. 15 is for explanatory and illustration purposes. FIG. 15 does not limit the scope of this disclosure to any particular implementation.

Referring to FIG. 15, STA 1 is a TXOP holder and is a non-LL STA or a legacy STA or a UHR STA with no LL traffic in the TXOP. STA 1 and STA 2 are associated with AP. AP is a TXOP responder and supports preemption of the TXOP. STA 2 is an LL STA and is able to preempt the TXOP. STA 1 transmits, to AP, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, AP transmits, to STA 1, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, STA 1 transmits, to AP, a frame (PPDU 1) as part of its periodic traffic with AP. During the PPDU 1, a UL LL packet arrives for AP. A XIFS period after the PPDU 1, STA 2 transmits, to STA 1 and AP, a PR frame requesting preemption for its UL LL packet for AP. The XIFS period is shorter than a SIFS period, allowing preemption of LL traffic. In response, AP transmits, to STA 2, a TF updating the TXOP duration. The TF updates the NAV setting of STAs that receive the frame. In response, STA 2 transmits, to AP, a frame (UL LL PPDU) including the UL LL packet. In response, AP transmits, to STA 2, a BA 1 frame acknowledging the UL LL PPDU. Subsequently, STA 1 transmits, to AP, a frame (PPDU 2) as part of its periodic traffic with AP. In response, AP transmits, to STA 1, a BA 2 frame acknowledging the PPDU 2.

In an embodiment, a preempting LL STA can transmit an extension request frame requesting that the TXOP holder extend the TXOP duration after transmitting the PR frame. The preempting LL STA may indicate the extension duration in the PR frame. In an embodiment, the TXOP holder may transmit an extension response frame including information, such as the dynamic duration capability of the TXOP, the maximum duration of the TXOP, the preemption capability of the TXOP, the number of updates to the TXOP duration, the maximum value for extension, and the duration of the extension. In an embodiment, the TXOP holder may reject the LL STA's request for TXOP duration extension. The TXOP holder may agree to extend the TXOP duration and then announce the updated TXOP duration in the extension announcement frame. In an embodiment, the TXOP holder may agree to extend the TXOP duration without transmitting an extension response frame or an extension announcement frame.

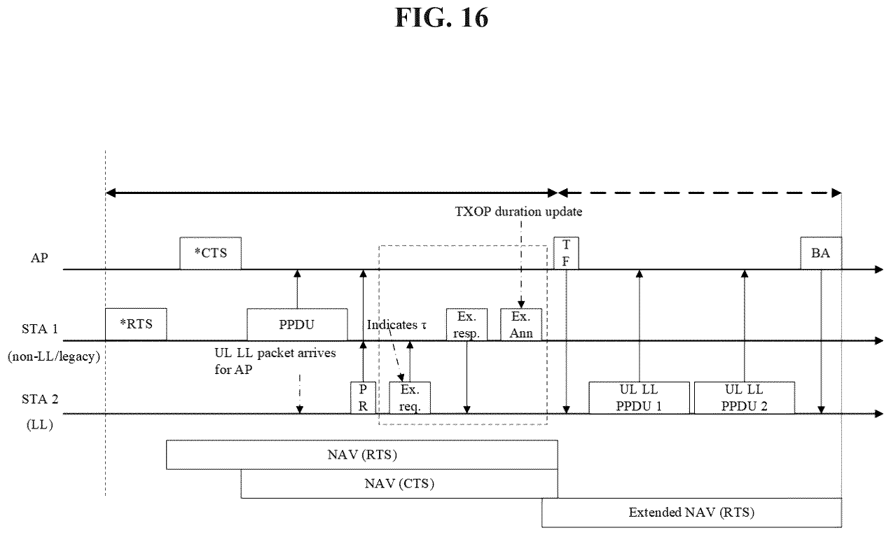

FIG. 16 shows another example of dynamic TXOP in accordance with an embodiment. The example depicted in FIG. 16 is for explanatory and illustration purposes. FIG. 16 does not limit the scope of this disclosure to any particular implementation.

Referring to FIG. 16, STA 1 is a TXOP holder and is a non-LL STA or a legacy STA or a UHR STA with no LL traffic in the TXOP. STA 1 and STA 2 are associated with AP. AP is a TXOP responder and supports preemption of the TXOP. STA 2 is an LL STA and is able to preempt the TXOP. STA 1 transmits, to AP, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, AP transmits, to STA 1, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, STA 1 transmits, to AP, a frame (PPDU) as part of its periodic traffic with AP. During the PPDU, a UL LL packet arrives for AP. After the PPDU, STA 2 transmits, to STA 1 and AP, a PR frame requesting preemption for transmission of its UL LL packet for AP. Subsequently, STA 2 transmits, to STA 1, an extension request (Ex. req.) frame indicating preemption duration t. In response, STA 1 transmits, to STA 2, an extension response (Ex. resp.) frame agreeing to extend the TXOP duration accordingly. Subsequently, STA 1 transmits an extension announcement frame updating the TXOP duration. The extension announcement frame updates the NAV setting of STAs that received the frame. In response, AP transmits, to STA 2, a TF. In response, STA 2 transmits, to AP, a frame (UL LL PPDU 1) including a first portion of the UL LL packet. Subsequently, STA 2 transmits, to AP, a frame (UL LL PPDU 2) including a second portion of the UL LL packet. In response, AP transmits, to STA 2, a BA frame acknowledging the UL LL PPDU.

In an embodiment, a TXOP responder may help update the TXOP duration in an uplink TF. In an embodiment, the TXOP responder may wait to transmit the uplink TF until the TXOP holder transmits an extension announcement frame. In an embodiment, the TXOP holder may transmit the extension announcement frame if the TXOP holder has received an extension request frame and the TXOP holder agrees to extend the TXOP duration. The announcement frame may include an extended duration and a maximum duration, for example the information items as shown in Table 4. In an embodiment, the TXOP holder may transmit an extension response frame including a deny code indicating the reasons for the rejection if it does not agree to extend the TXOP.

In an embodiment, when an AP requests to extend the TXOP duration, the AP may transmit a PR+BA frame. The AP may also transmit a frame (PR frame) including the information of the PR separately from a frame (BA frame) including the information of the BA. The AP may update the TXOP duration using the PR frame and the BA frame. In an embodiment, the TXOP holder may transmit a PRG frame including the updated TXOP duration. Therefore, all other STAs around the AP and TXOP holder may be aware of the updated TXOP duration.

In an embodiment, a TXOP holder or an LL STA may transmit a PR+BA frame or an extension announcement frame. The PR+BA frame may update the NAV setting for STAs that receive the frame. The extension announcement frame may update the NAV setting for STAs that receive the frame. The TXOP holder or the LL STA determine the extended TXOP duration when agreeing to the preemption.

In an embodiment, a dynamic TXOP may be defined as an elastic TXOP with a minimum and a maximum duration or an interval assigned by a TXOP holder. The elastic TXOP does not extend the TXOP duration but shortens it reserving the preemption duration Δ for necessary use.

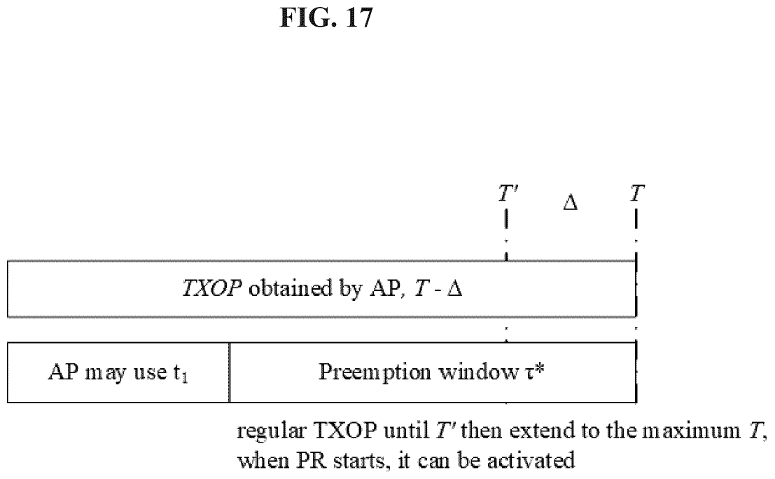

FIG. 17 shows another example of dynamic TXOP in accordance with an embodiment. The example depicted in FIG. 17 is for explanatory and illustration purposes. FIG. 17 does not limit the scope of this disclosure to any particular implementation.

Referring to FIG. 17, a TXOP holder, in this case the AP, obtains a TXOP of a duration T. The AP uses the TXOP for duration T′ to satisfy regular traffic needs and reserves duration Δ for necessary use. The AP can extend the TXOP by duration Δ so that traffic can finish transmission up to a duration T. The relationship of T, T′ and Δ with respect to the TXOP's duration is represented as the difference T-T′ is Δ. Below the TXOP is a representation of the use of the TXOP, where the AP has used the TXOP for a duration t₁. The remainder of the TXOP is available as a preemption window, represented by τ*, where the TXOP may be used for preemption. The extension of the TXOP to duration may occur in response to a request for preemption of the TXOP.

In an embodiment, when a transmission by a TXOP holder lacks sufficient time to finish, instead of extending the TXOP duration, the TXOP holder may adjust transmission capabilities, such as increasing MCS, NSS or providing more bandwidth, to satisfy the allocated TXOP limits. If the TXOP holder exceeds the TXOP limit, the TXOP holder should use as high a PHY rate as possible to minimize the duration of the TXOP and avoid interference with future schedules.

Channel access delay may occur with preemption in TXOP where there is a significant backlog of LL traffic waiting to preempt the channel and the LL traffic doesn't get the opportunity to preempt the channel. Channel access may also occur with preemption in TXOP where the LL traffic arrived near the end of the TXOP seeking preemption. Channel access delay may also occur with preemption in TXOP where the LL traffic arrived early and was delayed until the end of the TXOP because of preexisting backlog waiting to preempt the channel.

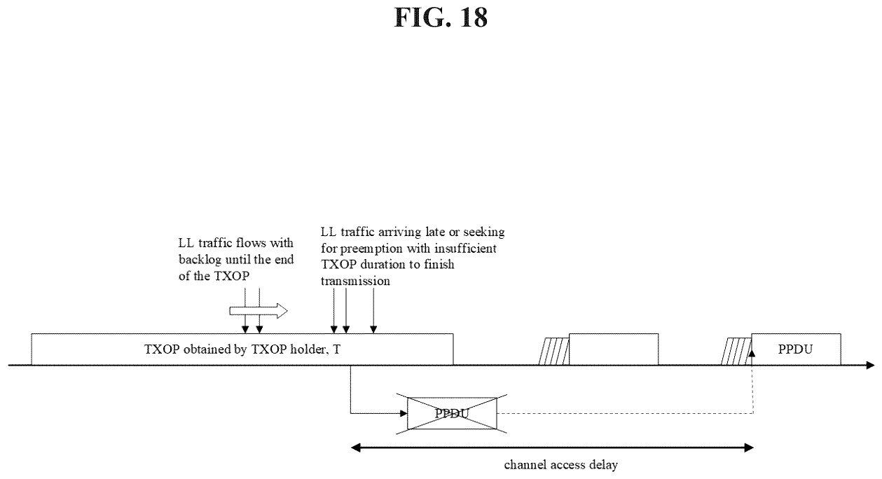

FIG. 18 shows another example of dynamic TXOP in accordance with an embodiment. The example depicted in FIG. 18 is for explanatory and illustration purposes. FIG. 18 does not limit the scope of this disclosure to any particular implementation.

Referring to FIG. 18, a TXOP holder obtains a TXOP of duration T. The TXOP holder may be a AP STA or a non-AP LL STA. There is a back log of LL traffic on the TXOP resulting in LL traffic that arrives with sufficient time to finish its transmission to suffer from channel access delay. LL traffic also arrives with insufficient time to finish its transmission during the TXOP resulting in the LL traffic to suffer from channel access delay. LL traffic that attempts to preempt the TXOP arrives within sufficient time to preempt existing LL traffic and finish its transmission during the TXOP. The effect of channel access delay is that the LL traffic that cannot finish during the TXOP waits until the LL traffic has sufficient time to finish its transmission. In an embodiment, the PPDU may be dropped and only finish its transmission significantly later than needed.

In an embodiment, a dynamic TXOP is defined such that the duration may be dynamic by way of using different duration limits.

In an embodiment, late LL traffic could be defined as LL traffic where a preemption request is transmitted but the TXOP holder lacks sufficient time to schedule the LL PPDU's transmission in the current TXOP duration. In an embodiment, late LL traffic could be defined as LL traffic where a preemption request is transmitted but there is insufficient time to finish transmission for all of the LL PPDU within the remaining TXOP. In an embodiment, late LL traffic could be defined as LL traffic where a preemption request is transmitted but there is insufficient time for the LL STA and the TXOP holder to adjust capabilities to finish transmission within the remaining TXOP. In an embodiment, late LL traffic could be defined as LL traffic where there is insufficient time for a preemption request to be transmitted. In an embodiment, late LL traffic could be defined as LL traffic where a small number of PPDUs including the accompanying SIFSs can result in insufficient duration for preemption.

In an embodiment, T is a maximum TXOP limit, which may be referred to as a first-class limit. T′ is a TXOP duration limit, which may be referred to as a second-class limit that. The second-class limit intends to prepare the LL STAs for preemption within the T′ limit. Most traffic should consider adjusting their capabilities to finish before T′. In an embodiment, an LL STA may identify the second-class limit and switch to a high capability such as high MCS or NSS. In an embodiment, the TXOP holder may transmit a request frame to adjust the capability of an LL STA.

In an embodiment, the TXOP holder may release the channel when there is no preemption or preemption finishes earlier before T′ by transmitting a CF-end frame prior to T′. The maximum duration of the TXOP, T, is used when preemption occurs and doesn't finish before T′, and the TXOP may be used until T.

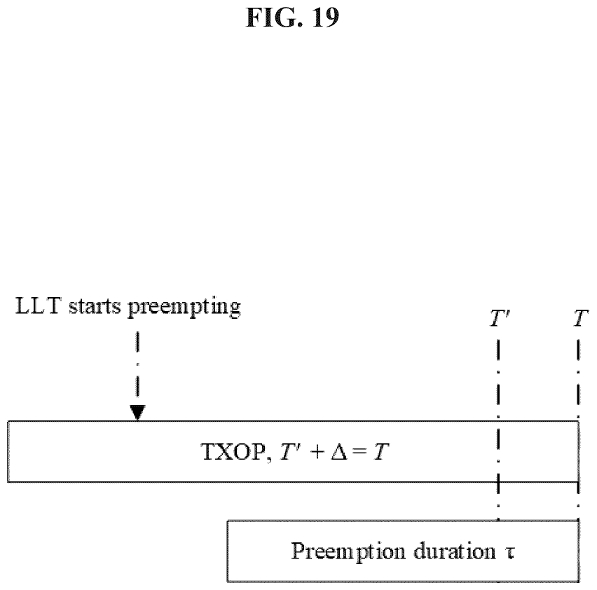

FIG. 19 shows another example of dynamic TXOP in accordance with an embodiment. The example depicted in FIG. 19 is for explanatory and illustration purposes. FIG. 19 does not limit the scope of this disclosure to any particular implementation.

Referring to FIG. 19, a TXOP holder obtains TXOP for a duration T. The first class-limit for TXOP is the duration T and the second-class limit for TXOP is duration T′, where T′+Δ=T. Δ is the difference between T′ and T. LL traffic starts preempting the TXOP prior to T′ with a preemption duration of τ. The TXOP holder does not release the TXOP at T′ because of the presence of preemption by the LL traffic on the TXOP. The LL traffic finishes preempting the TXOP at T and the TXOP completes.

In a TXOP, a preemption window describes the duration available for an LL traffic to perform preemption on the TXOP. A preemption window includes information items as shown in Table 6. The constraint present on the second-class duration limit should activate earlier since an aperiodic event may occur arbitrarily which may result in interference if the TXOP cannot reserve the duration Δ.

TABLE 6

| Subfield | Description |
|---|---|
| Second-class duration limit | An item that indicates a time stamp such that the LL traffic may |
| | try to finish before it, but if not, the STA should use as high as |
| | PHY rate and high capability as possible to minimize the |
| | duration of the TXOP |
| The duration residue A | An item that indicates the difference of the two limits, |
| | Δ = T − T′ |

In an embodiment, a TXOP holder and a preemptor, an LL STA, should use as high a PHY rate as possible if the preemptable TXOP holder exceeds the second-class TXOP limit.

In an embodiment, an AP may advertise the T and T′ limit in the enhanced distributed channel access (EDCA) parameter set element in a beacon frame or a probe response frame. In an embodiment, the TXOP holder may use the EDCA parameters when they perform TXOP-based preemption. In an embodiment, the AP may indicate T′ in the preemption field/element in UHR operation.

In an embodiment, the TXOP holder may transmit a contention free (CF)-end frame that will reset the NAV for STAs that receive the frame. The STAs that received the CF-end frame can start contention for the TXOP without delay. A CF-end is always preferred in this case such that the rest of the channel, such as Δ, can be released earlier. Once a CF-end frame has been transmitted, the TXOP is complete and no preemption is allowed.

In an embodiment, the duration of Δ is constrained where, for example, A needs to be at least as long as a duration of CF-end+SIFS+DIFS. In an embodiment, the duration of A, for example, is a duration of one PPDU plus SIFS.

In an embodiment, legacy STAs may update their NAV setting to T so as not to contend for the channel of a TXOP until the TXOP has completed. The TXOP holder transmits a CF-end frame completing the TXOP. The CF-end frame resets the NAV for STAs that received it. In an embodiment, legacy STAs may update the NAV setting to T′ and may be awake to listen the channel after T′.

In an embodiment, PSM STAs may wake prior to T′ and wait for the CF-end frame. If the PSM STAs do not receive a CF-end frame before T′ then the PSM STAs may begin contention for the channel, preserving efficiency and fairness in contention. In an embodiment, STAs could set themselves in PSM until T, allowing non-PSM STA to have a better chance to access the channel since they may start contending for the channel at T′. These PSM STAs may be STAs with less latency sensitive traffic.

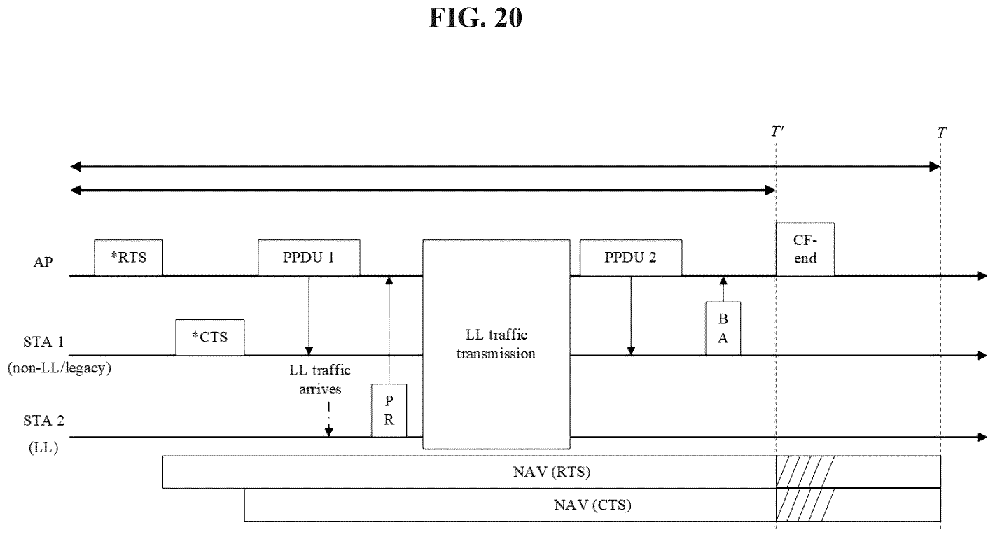

FIG. 20 shows another example of dynamic TXOP in accordance with an embodiment. The example depicted in FIG. 20 is for explanatory and illustration purposes. FIG. 20 does not limit the scope of this disclosure to any particular implementation.

Referring to FIG. 20, AP is a TXOP holder. STA 1 and STA 2 are associated with AP. STA 1 is a TXOP responder and is a non-LL STA or a legacy STA or a UHR STA with no LL traffic in the TXOP. STA 1 supports preemption of the TXOP. STA 2 is an LL STA and is able to preempt the TXOP. AP transmits, to STA 1, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, STA 1 transmits, to AP, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, AP transmits, to STA 1, a frame (PPDU 1) as part of its periodic traffic with STA 1. During the PPDU 1, LL traffic arrives from STA 2. After the PPDU 1, STA 2 transmits, to AP, a PR frame requesting preemption for its LL traffic. Subsequently, STA 2 performs the LL traffic transmission preempting AP's periodic traffic with STA 1. Subsequently, AP transmits, to STA 1, a frame (PPDU 2) as part of its periodic traffic with STA 1. In response, STA 1 transmits a BA frame acknowledging the PPDU 2. Subsequently, AP transmits a CF-end frame at T′ completing the TXOP before T.

In an embodiment, a TXOP holder may announce T′ and T before the TXOP duration begins. The TXOP holder may be a non-AP STA or an AP STA. The TXOP holder may also indicate that the TXOP is a preemptable TXOP. The TXOP holder may suspend regular traffic to a TXOP responder after a preemption request frame is received. The TXOP receiver may be a non-AP STA or an AP STA. Once the preempting LL traffic transmission is finished, the TXOP holder may continue to perform the regular transmission with the TXOP responder. The TXOP holder may adjust its capabilities to finish the transmission before T′. If there is no new preemption occurring, the TXOP holder can transmit a CF-end frame to complete the TXOP.

In an embodiment, the TXOP responder may update the NAV setting and begin contending for the channel after receiving a CF-end frame from the TXOP holder. The TXOP responder may also contend after T′ if the TXOP responder does not detect a CF-end frame sent by the TXOP holder.

In an embodiment, an LL STA may not need to adjust its capability if the LL STA can finish its transmission before T′. The LL STA may adjust its capability if the LL STA cannot finish its transmission before T′ but can finish before T. The LL STA needs to adjust the capability and indicate the remaining duration that the LL STA needs to the TXOP holder, such that TXOP holder may also adjust its capability, if the LL STA cannot finish its transmission within T in its current capability.

In an embodiment, legacy STAs may wake up after T′ and listen to the channel if the legacy STAs chose to sleep during the TXOP until T′. The legacy STAs may begin contending for the channel after receiving a CF-end frame from the TXOP holder. The legacy STAs may contend for the channel after T, if the legacy STAs chose to sleep until T.

In an embodiment, LL STAs may detect if the TXOP is preemptable or not. The LL STAs that have membership with an AP (STAs that have registered with the AP, are associated with the AP and who may preempt in the TXOP) may stay awake in the case of LL traffic if the TXOP is preemptable. Other STAs that may not have the membership may be in the power saving mode either until T′ or T.

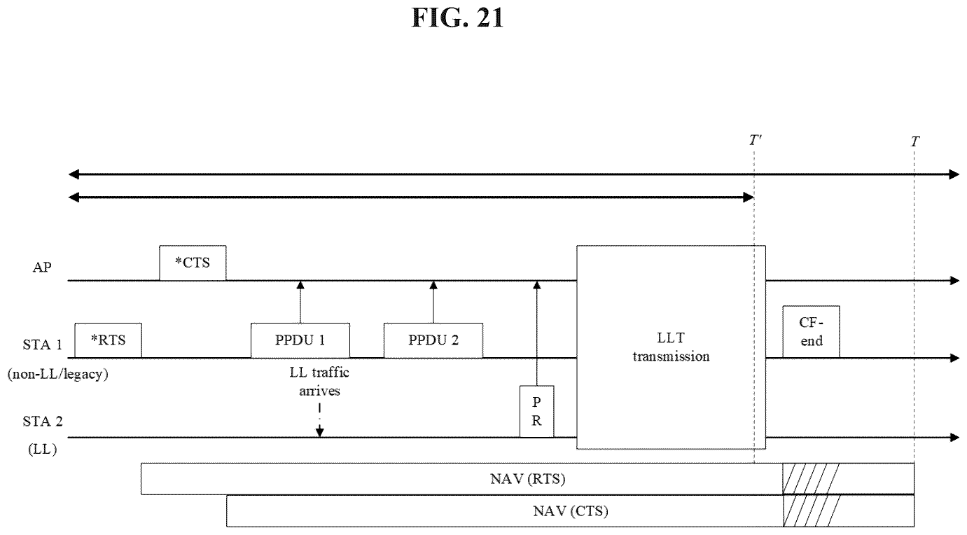

FIG. 21 shows an example of dynamic TXOP in accordance with an embodiment. The example depicted in FIG. 21 is for explanatory and illustration purposes. FIG. 21 does not limit the scope of this disclosure to any particular implementation.

Referring to FIG. 21, the STA 1 is a TXOP holder and is a non-LL STA or a legacy STA or a UHR STA with no LL traffic in the TXOP. STA 1 and STA 2 are associated with AP. AP is a TXOP responder and supports preemption of the TXOP. STA 2 is an LL STA and is able to preempt the TXOP. STA 1 transmits, to AP, a modified RTS frame (*RTS) including TXOP information, such as, the dynamic duration capability of the TXOP, the maximum duration of the TXOP, the preemption capability of the TXOP and the number of updates to the TXOP duration, for example, the new information items of Table 3. The modified RTS frame updates the NAV setting for STAs that received the control frame. In an embodiment, any other control frame including similar information may replace the modified RTS frame. In response, AP transmits, to STA 1, a modified CTS frame (*CTS) including TXOP information, such as, the dynamic duration capability of the TXOP, the maximum duration of the TXOP, the preemption capability of the TXOP and the number of updates to the TXOP duration, for example, the new information items of Table 3. The modified CTS frame updates the NAV setting for STAs that received the control frame. In an embodiment, any other control frame including similar information may replace the modified CTS frame. In response, STA 1 transmits, to AP, a frame (PPDU 1) as part of its periodic traffic with AP. During the PPDU 1, LL traffic arrives from STA 2. Subsequently, STA 1 transmits, to AP, a frame (PPDU 2) as part of its periodic traffic with AP. Following the PPDU 2, STA 2 transmits, to AP, a PR frame requesting preemption for its LL traffic. Subsequently, STA 2 performs the LL traffic transmission preempting AP's periodic traffic with STA 1. Subsequently, STA 1 transmits a CF-end frame after T′ but before T completing the TXOP.

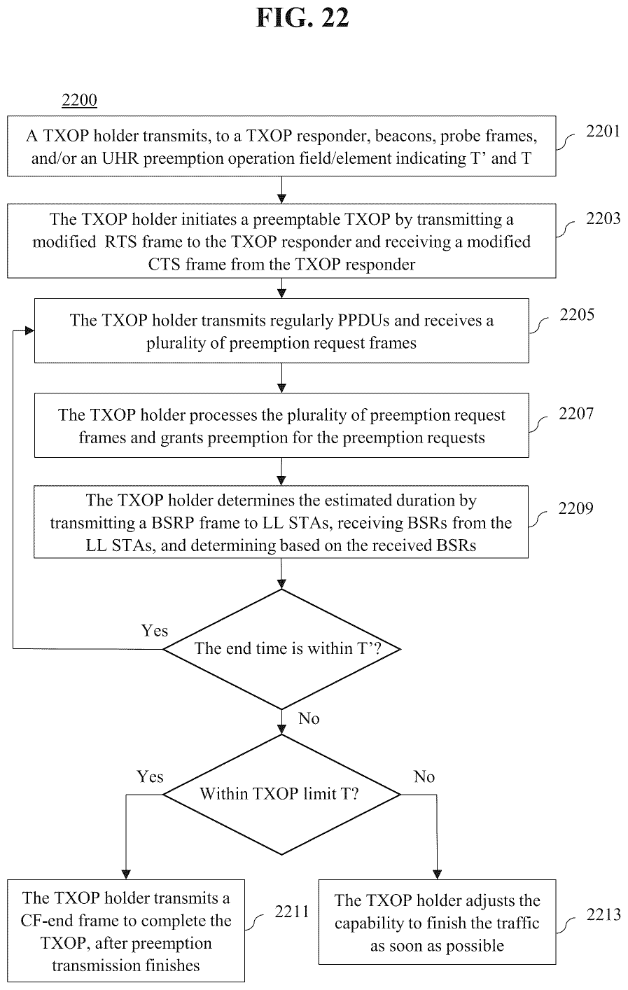

FIG. 22 shows an example process of dynamic TXOP in accordance with an embodiment. The example process depicted in FIG. 22 is for explanatory and illustration purposes. FIG. 22 does not limit the scope of this disclosure to any particular implementation.

Referring to FIG. 22, the process 2200 begins at operation 2201. In operation 2201, a TXOP holder transmits, to a TXOP responder, beacons, probe frames, and/or an UHR preemption operation field/element indicating T′ and T. The TXOP holder may be an AP or a non-AP STA. The TXOP responder may be an AP or a non-AP STA.

In operation 2203, the TXOP holder initiates a preemptable TXOP by transmitting a modified RTS frame and receiving a modified CTS frame from the TXOP responder.

In operation 2205, the TXOP holder transmits regularly PPDUs and receives a plurality of preemption request frames. The TXOP holder may suspend regular transmission of PPDUs after receiving a preemption request frame.

In operation 2207, the TXOP holder processes the plurality of preemption request frames and grants the preemption for the preemption requests. The TXOP holder may reject the preemption request if there is insufficient time remaining in the TXOP duration.

In operation 2209, the TXOP holder determines the estimated duration by transmitting, to LL STAs that request preemption, a BSRP frame, receiving BSRs from the LL STAs, and determining based on the received BSRs. Operation 2209 may be followed by operation 2205 if the end time of the transmission is within T′. Operation 2209 may be followed by operation 2211 if the end time is not within T′ and end time is within the TXOP limit T. Operation 2209 may be followed by operation 2213 if the end time is not within either T′ or T.

In operation 2211, the TXOP holder transmits a CF-end frame to complete the TXOP after the preemption transmission finishes.

In operation 2213, the TXOP holder adjusts the capability to finish the traffic as soon as possible so that the traffic finishes before the TXOP completes.

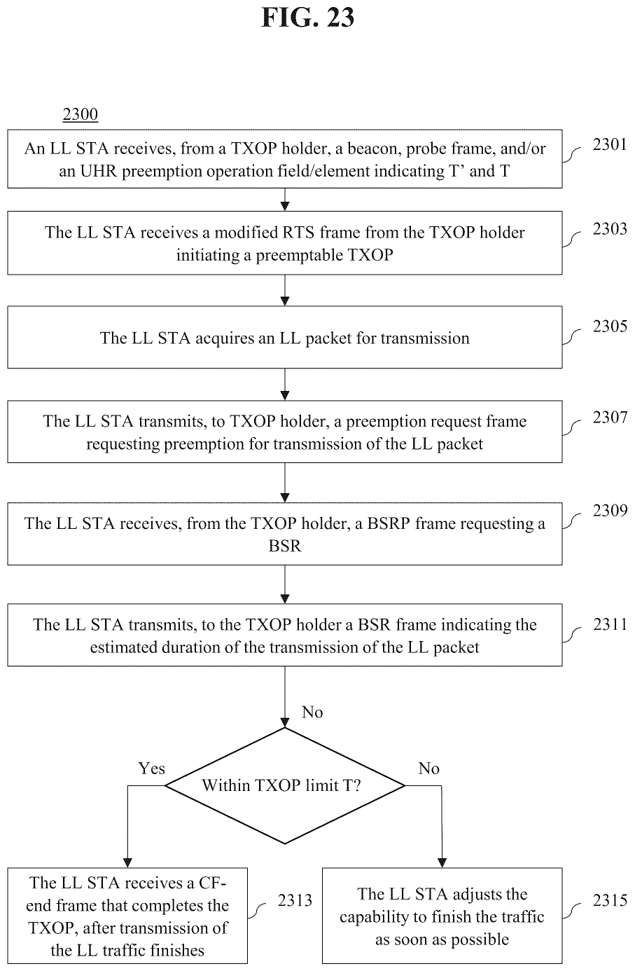

FIG. 23 shows another example process of dynamic TXOP in accordance with an embodiment. The example process depicted in FIG. 23 is for explanatory and illustration purposes. FIG. 23 does not limit the scope of this disclosure to any particular implementation.

Referring to FIG. 23, the process 2300 begins at operation 2301. In operation 2301, an LL STA receives, from a TXOP holder, a beacon, probe frame, and/or an UHR preemption operation field/element indicating T′ and T. The LL STA may be associated with the TXOP holder if the TXOP holder is an AP STA or in the same BSS if the TXOP holder is a non-AP STA. The LL STA may be able to preempt the TXOP.

In operation 2303, the LL STA receives a modified RTS frame from the TXOP holder initiating a preemptable TXOP. The LL STA may receive a modified CTS frame from a TXOP responder. The LL STA may use the modified RTS frame or the modified CTS frame to update its NAV setting.

In operation 2305, the LL STA acquires an LL packet for transmission. The LL packet may arrive while the channel is busy.

In operation 2307, the LL STA transmits, to TXOP holder, a preemption request frame requesting preemption for transmission of the LL packet. The LL STA may transmit the preemption request frame after a shorter IFS, XIFS, from the transmission of a frame resulting in the channel being busy.

In operation 2309, the LL STA receives, from the TXOP holder, a BSRP frame requesting a BSR. The BSRP may include UORA.

In operation 2311, the LL STA transmits, to the TXOP holder a BSR frame indicating the estimated duration of the LL STA's transmission. Operation 2311 is followed by operation 2313 if the estimated duration of LL STA's transmission would cause the transmission to finish within the TXOP limit T. Operation 2311 is follow by operation 2315 if the estimated duration of LL STA's transmission would cause the transmission to not finish within the TXOP limit T.

In operation 2313, the LL STA receives a CF-end frame that completes the TXOP, after transmission of the LL traffic finishes. The LL STA may not receive a CF-end frame but the TXOP will be completed by time T.

In operation 2315, the LL STA adjusts the capability to finish the traffic as soon as possible. The LL STA may be unable to sufficiently adjust the capability to finish the traffic on its own, either resulting in the LL traffic dropping or relying on capability adjustments of the TXOP holder.

The disclosure provides mechanisms and procedures for a dynamic TXOP in preemption, such as extending the TXOP duration to avoid dropping traffic during or after preemption or completing the TXOP before the TXOP duration to reserve the TXOP duration.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in a different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory; and
a processor coupled to the memory, the processor configured to cause:
obtaining a transmission opportunity (TXOP) on a wireless channel;
determining whether a TXOP duration needs to be extended to transmit or receive low-latency traffic; and
transmitting, to a plurality of stations (STAs), a frame announcing an extension of the TXOP duration based on a determination that the TXOP duration needs to be extended, the frame including duration information associated with the extension of the TXOP duration.

2. The AP of claim 1, wherein:
the processor is further configured to cause receiving, from one or more STAs, a request frame for the extension of the TXOP duration, the request frame including duration information associated with the low-latency traffic; and
the determining whether the TXOP duration needs to be extended comprising determining whether the low-latency traffic is allowed to be transmitted or received within the TXOP duration based on the duration information associated with the low-latency traffic.

3. The AP of claim 1, wherein the processor is further configured to cause:
updating the TXOP duration to an extended TXOP duration; and
transmitting or receiving the low-latency traffic during the extended TXOP duration.

4. The AP of claim 1, wherein the duration information associated with the extension of the TXOP duration is used for one or more legacy STAs to update a network allocation vector (NAV).

5. The AP of claim 1, wherein the processor is further configured to cause:
transmitting, to one or more STAs, a request frame soliciting a buffer status report; and
receiving, from at least one of the one or more STAs, a response frame including a buffer status report in response to the request frame.

6. The AP of claim 1, wherein the processor is further configured to cause:
receiving, from one or more STAs, a request frame indicating a need for preemption of the TXOP for transmitting or receiving the low-latency traffic;
determining whether to prioritize transmitting or receiving the low-latency traffic based on the duration information associated with the low-latency traffic; and
prioritizing transmitting or receiving the low-latency traffic based on a determination to prioritize transmitting or receiving the low-latency traffic.

7. The AP of claim 1, wherein the frame is a trigger frame to solicit the low-latency traffic.

8. The AP of claim 1, wherein:
the determining whether the TXOP duration needs to be extended comprising determining whether the low-latency traffic is allowed to be transmitted within the TXOP duration by changing one or more transmission capabilities of the AP; and
the processor is further configured to cause changing the one or more transmission capabilities of the AP based on a determination that the low-latency traffic is allowed to be transmitted within the TXOP duration.

9. The AP of claim 1, wherein the processor is further configured to cause:
determining that the AP finishes transmitting or receiving the low-latency traffic before the TXOP duration; and
transmitting a contention free (CF)-end frame that ends the TXOP after the transmitting or receiving the low-latency traffic and before the end of the TXOP duration.

10. The AP of claim 1, wherein the processor is further configured to cause:
transmitting a request-to-send (RTS) frame including information associated with the TXOP duration; and
receiving a clear-to-send (CTS) frame including information associated with the TXOP duration.

11. A station (STA) for facilitating communication in a wireless network, comprising:
a memory; and
a processor coupled to the memory, the processor configured to cause:
receiving, from an access point (AP), a frame indicating a transmission opportunity (TXOP) duration;
transmitting, to the AP, a request frame for transmission of low-latency traffic;
receiving, from the AP, a frame announcing an extension of the TXOP duration, the frame including duration information associated with the extension of the TXOP duration; and
transmitting, to the AP, the low latency traffic within an extended TXOP duration indicated by the duration information.

12. The STA of claim 11, wherein the request frame includes duration information associated with the low-latency traffic.

13. The STA of claim 11, wherein the STA is a non-legacy STA.

14. The STA of claim 11, wherein the duration information associated with the extension of the TXOP duration is used for one or more legacy STAs to update a network allocation vector (NAV).

15. The STA of claim 11, wherein the processor is further configured to cause:
receiving, from the AP, a request frame soliciting a buffer status report; and
transmitting, to the AP, a response frame including a buffer status report indicating a duration of the low latency traffic in response to the request frame.

16. The STA of claim 11, wherein the request frame indicates a need for preemption of the TXOP for transmission of the low-latency traffic.

17. The STA of claim 11, wherein the frame is a trigger frame to solicit the low-latency traffic.

18. The STA of claim 11, wherein the processor is further configured to cause:
receiving, from the AP, a contention free (CF)-end frame that ends the TXOP before an extended TXOP duration; and
contending for a wireless channel for transmission of non-low-latency traffic.

19. The STA of claim 11, wherein the processor is further configured to cause:
receiving a request-to-send (RTS) frame including information associated with the TXOP duration; and
receiving a clear-to-send (CTS) frame including information associated with the TXOP duration.

20. The STA of claim 19, wherein the processor is further configured to cause:
determining whether there is a need to adjust the STA's capabilities based on the information associated with TXOP duration and the low-latency traffic.
